(19) United States
(12) Patent Application Publication
(10) Pub. No.: US 2026/0250138 A1
(43) Pub. Date: Aug. 27, 2026

(54) REVERSE WATER GAS SHIFT CATALYSTS COMPRISING AN ALKALI METAL AND ALUMINA

(71) Applicant: SAUDI ARABIAN OIL COMPANY, Dhahran (SA)

(72) Inventors: Mohammed A. AL-DAOUS, Dhahran (SA); Khaled NAFEE, Dhahran (SA)

(73) Assignee: SAUDI ARABIAN OIL COMPANY, Dhahran (SA)

(21) Appl. No.: 19/062,818

(22) Filed: Feb. 25, 2025

(51) Int. Cl. C01B 32/40; B01J 21/04; B01J 23/04; B01J 35/40; B01J 37/04; B01J 37/08; C01B 3/50; C10K 1/00

(52) U.S. Cl. CPC C01B 32/40; B01J 21/04; B01J 23/04; B01J 35/40; B01J 37/04; B01J 37/08; C01B 3/50; C10K 1/005; C01B 2203/1276

(57) ABSTRACT

The reverse water-gas shift reaction catalysts comprising an alkali metal supported on alumina. Embodiments generally relate to catalysts for reverse water-gas shift (RWGS), methods for making the catalysts, and methods for using the catalysts in RWGS reactions. The disclosure generally relates to catalysts comprising at least one alkali metal on alumina (Al₂O₃), wherein the alumina in a phase selected from the group consisting of alpha-alumina (α-Al₂O₃) phase, theta-alumina (θ-Al₂O₃) phase, gamma-alumina (γ-Al₂O₃) phase, and any combination thereof. The catalysts are in a form of a plurality of particles having an average particle size of about 200 micrometers to about 500 micrometers.

### FIELD OF THE DISCLOSURE

The present disclosure relates generally to reverse water-gas shift reaction catalysts and, more particularly, to alkali metal(s) supported on alumina (Al₂O₃) as the catalysts for reverse water-gas shift reactions.

### BACKGROUND OF THE DISCLOSURE

The catalytic reduction of carbon dioxide (CO₂) into a value-added product holds enormous economic and environmental potential. Water-gas shift reactions (WGSR) are reactions of carbon monoxide (CO) and water to form carbon dioxide (CO₂) gas and hydrogen (H₂) gas. Reverse water-gas shift (RWGS) reactions are used to produce carbon monoxide (CO) gas from hydrogen (H₂) gas and carbon dioxide (CO₂). RWGS reactions are equilibrium reactions that are favored at high reaction temperatures due to their moderate exothermic character. Often precious metals are used as catalysts for RWGS reactions. A challenge with RWGS reactions is that the carbon dioxide (CO₂) gas may often be over-reduced to methane (CH₄) gas instead of stopping at the useful syngas stage. The acidity of the catalysts is the main physicochemical property responsible for the excessive hydrogenation of carbon dioxide (CO₂) to methane (CH₄) gas.

Usually, precious metal catalysts have to be utilized for RWGS reactions which can make performing the reactions expensive and inconvenient. For examples of precious metal catalyzed RWGS reactions, see U.S. Pat. App. Pub. No. 2024/0270572 A1, the disclosure of which is hereby incorporated by reference in its entirety. If precious metals are not utilized as catalysts, then the reaction temperatures for the RWGS reactions usually must be at least 1000° C., which can make operational conditions extremely challenging. For examples of RWGS reactions without a precious metal catalyst but with reaction temperatures of at least 1000° C., see U.S. Pat. No. 11,964,872, the disclosure of which is hereby incorporated by reference in its entirety.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, catalysts comprise alumina in a phase selected from the group consisting of alpha-alumina (α-Al₂O₃) phase, theta-alumina (θ-Al₂O₃) phase, gamma-alumina (γ-Al₂O₃) phase, and any combination thereof; and an alkali metal in an amount of about 1 weight % to about 9.5 weight % per the catalyst; wherein the catalysts are in a form of a plurality of particles having an average particle size of about 200 micrometers to about 500 micrometers.

In another embodiment, methods comprise: combining alumina (Al₂O₃) and a solution comprising an alkali metal compound to produce a homogeneous paste; drying the homogeneous paste at about 120° C. for at least about 24 hours; and calcining the homogenous paste for at least about 1 hour at a calcining temperature of at least about 550° C. to produce a catalyst comprising the alkali metal and the alumina.

In a further embodiment, methods comprise: introducing a catalyst into a chemical reactor; activating the catalysts by heating the catalysts to an activation temperature of at least about 650° C. at a rate of about 5° C./min to about 15° C./min under argon; flowing a feed composition at a Gas Hourly Space Velocity of about 3300 mL (grams of catalyst)⁻¹ hour⁻¹ to about 13,200 mL (grams of catalyst)⁻¹ hour⁻¹ into the chemical reactor, wherein the feed composition comprises CO₂ and H₂; maintaining the chemical reactor at a reaction temperature of about 550° C. to about 900° C. and a pressure of about atmospheric pressure to about 5 bar gauge (barg); and recovering a first mixture stream leaving the chemical reactor, wherein the first mixture stream comprises: water (H₂O) vapor, unreacted carbon dioxide (CO₂) gas, unreacted hydrogen (H₂) gas, and carbon monoxide (CO) gas; and wherein the catalyst comprises alumina in a phase selected from the group consisting of alpha-alumina (α-Al₂O₃) phase, theta-alumina (θ-Al₂O₃) phase, gamma-alumina (γ-Al₂O₃) phase, and any combination thereof; and an alkali metal in an amount of about 1 weight % to about 9.5 weight % per the catalyst; wherein the catalysts are in a form of a plurality of particles having an average particle size of about 200 micrometers to about 500 micrometers.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

The following figures are included to illustrate certain aspects of the embodiments. The subject matter disclosed is capable of considerable modifications, alterations, combinations and equivalents in form and function, as will occur to those skilled in the art and having the benefit of this disclosure.

FIG. 1 illustrates an example of a chemical reactor producing a syngas mixture stream, a first carbon dioxide (CO₂) gas stream, a first hydrogen (H₂) gas stream, and a first carbon monoxide (CO) gas stream.

FIG. 2 illustrates an example of a chemical reactor producing a third mixture stream, a second carbon dioxide (CO₂) gas stream, a second hydrogen (H₂) gas stream, and a second carbon monoxide (CO) gas stream.

### DETAILED DESCRIPTION

Embodiments in accordance with the present disclosure generally relate to catalysts for reverse water-gas shift (RWGS) reactions, methods for making the catalysts, and methods for using the catalysts in reverse water-gas shift (RWGS) reactions (i.e., performing the reverse water-gas shift (RWGS) reactions with the catalysts). More particularly, the present disclosure generally relates to catalysts comprising at least one alkali metal on alumina (Al₂O₃). Embodiments relate to utilizing non-precious metal catalysts for the RWGS reactions at reaction temperatures below 1000° C.

Abbreviations are as follows: grams (g), meters (m), centimeters (cm), millimeters (mm), micrometer (μm), liters (L), milliliters (mL), parts per million (ppm), atmospheric pressure (atm), and minutes (min).

Catalysts for the RWGS reactions comprise at least one alkali metal on alumina (Al₂O₃). Reagents for the RWGS reactions comprise phases of alumina (Al₂O₃) without an alkali metal. Examples of the reagents used include, but are not limited to, reagent-1, reagent-5, reagent-9, and any combination thereof.

In some embodiments of the present disclosure, the catalysts comprise: alumina in a phase selected from the group consisting of alpha-alumina (α-Al₂O₃) phase, theta-alumina (θ-Al₂O₃) phase, gamma-alumina (γ-Al₂O₃) phase, and any combination thereof; and an alkali metal in an amount of about 1 weight % to about 9.5 weight % per the catalyst; wherein the catalysts are in a form of a plurality of particles having an average particle size of about 200 micrometers to about 500 micrometers.

For the catalysts, the plurality of particles have an average particle size of about 200 micrometers to about 500 micrometers, or of about 250 micrometers to about 450 micrometers, or of about 300 micrometers to about 400 micrometers, or of about 350 micrometers to about 380 micrometers.

In some embodiments of the present disclosure, the catalysts comprise: alumina in a phase selected from the group consisting of alpha-alumina (α-Al₂O₃) phase, theta-alumina (θ-Al₂O₃) phase, gamma-alumina (γ-Al₂O₃) phase, and any combination thereof; and an alkali metal in an amount of about 1 weight % to about 9.5 weight % per the catalyst; wherein the catalysts are in a form of a plurality of particles having an average particle size of about 200 micrometers to about 500 micrometers; and further wherein the alkali metal is selected from the group consisting of lithium (Li), sodium (Na), potassium (K), cesium (caesium) (Cs), and any combination thereof.

In some embodiments of the present disclosure, the catalysts comprise: alumina in a phase selected from the group consisting of alpha-alumina (α-Al₂O₃) phase, theta-alumina (θ-Al₂O₃) phase, gamma-alumina (γ-Al₂O₃) phase, and any combination thereof; and an alkali metal in an amount of about 1 weight % to about 9.5 weight % per the catalyst; wherein the catalysts are in a form of a plurality of particles having an average particle size of about 200 micrometers to about 500 micrometers; and further wherein the alkali metal is selected from the group consisting of lithium (Li), potassium (K), cesium (caesium) (Cs), and any combination thereof.

Alumina (Al₂O₃) may be used as a catalyst support. A catalyst support is a material, with a high surface area, to which catalyst may be affixed.

Alumina (Al₂O₃; aluminium (III) oxide; aluminum (III) oxide) may be found in a variety of phases. Some examples of the phases of alumina include, but are not limited to, alpha-alumina (α-Al₂O₃) phase, beta-alumina phase, gamma-alumina (γ-Al₂O₃) phase, delta-alumina (δ-Al₂O₃) phase, epsilon-alumina (ε-Al₂O₃) phase, zeta-alumina (ζ-Al₂O₃) phase, eta-alumina (η-Al₂O₃) phase, theta-alumina (θ-Al₂O₃) phase, iota-alumina (τ-Al₂O₃) phase, kappa-alumina (κ-Al₂O₃) phase, lambda-alumina (λ-Al₂O₃) phase, mu-alumina (μ-Al₂O₃) phase, nu-alumina (ν-Al₂O₃) phase, xi-alumina (ξ-Al₂O₃) phase, omicron-alumina (o-Al₂O₃) phase, pi-alumina (π-Al₂O₃) phase, rho-alumina (ρ-Al₂O₃) phase, sigma-alumina (σ-Al₂O₃) phase, tau-alumina (τ-Al₂O₃) phase, upsilon-alumina (υ-Al₂O₃) phase, phi-alumina (φ-Al₂O₃) phase, chi-alumina (χ-Al₂O₃) phase, psi-alumina (ψ-Al₂O₃) phase, omega-alumina (ω-Al₂O₃) phase, and any combination thereof. Beta-alumina is a generic term used to describe compositions in the range Na₂O·11Al₂O₃ (β-alumina, β-Al₂O₃) to Na₂O·5Al₂O₃ (β″-alumina, β″-Al₂O₃). Additions of small amounts of MgO and/or Li₂O may be used to modify β″-alumina.

In some embodiments, the more thermodynamically stable phases of alpha-alumina (α-Al₂O₃) and theta-alumina (θ-Al₂O₃) may have greater stability against sintering under the high reaction temperatures of the RWGS reactions.

The alkali metal(s) to be introduced to the alumina (Al₂O₃) for the catalysts may be selected from the group consisting of lithium (Li), sodium (Na), potassium (K), cesium (caesium) (Cs), and any combination thereof. Heavy alkali metals, such as potassium (K) and cesium (caesium) (Cs), may have a lower tendency to acquire mobility when compared to lithium (Li) and sodium (Na) under the hydrothermal conditions that are usually prevalent during both the RWGS reactions and the regeneration of the catalysts. The addition of the alkali metal(s) to the alumina (Al₂O₃) may limit the acidity of the alumina (Al₂O₃), which may provide the reactions with the desired performance and selectivity (i.e., preventing excessive hydrogenation of the carbon dioxide (CO₂) gas).

In some embodiments of the present disclosure, the catalysts comprise: alumina in a phase selected from the group consisting of alpha-alumina (α-Al₂O₃) phase, theta-alumina (θ-Al₂O₃) phase, gamma-alumina (γ-Al₂O₃) phase, and any combination thereof; and an alkali metal in an amount of about 1 weight % to about 6 weight % per the catalyst; wherein the catalysts are in a form of a plurality of particles having an average particle size of about 200 micrometers to about 500 micrometers. In some embodiments of the present disclosure, the catalysts comprise: alumina in a phase selected from the group consisting of alpha-alumina (α-Al₂O₃) phase, theta-alumina (θ-Al₂O₃) phase, gamma-alumina (γ-Al₂O₃) phase, and any combination thereof; and an alkali metal in an amount of about 1 weight % to about 6 weight % per the catalyst; wherein the catalysts are in a form of a plurality of particles having an average particle size of about 200 micrometers to about 500 micrometers; and further wherein the alkali metal is selected from the group consisting of lithium (Li), sodium (Na), potassium (K), cesium (caesium) (Cs), and any combination thereof.

For the catalysts, the weight % of alkali metal per catalyst may be in the range of about 0.00001 weight % of alkali metal per catalyst to about 99 weight % of alkali metal per catalyst. For example, the weight % of alkali metal per catalyst may be in the range of about 0.0001 weight % of alkali metal per catalyst to about 10 weight % of alkali metal per catalyst, such as, of about 0.5 weight % of alkali metal per catalyst to about 9.5 weight % of alkali metal per catalyst, or of about 1 weight % of alkali metal per catalyst to about 9 weight % of alkali metal per catalyst, or of about 1.5 weight % of alkali metal per catalyst to about 8 weight % of alkali metal per catalyst, or of about 1.79 weight % of alkali metal per catalyst to about 7 weight % of alkali metal per catalyst, or of about 2 weight % of alkali metal per catalyst to about 6 weight % of alkali metal per catalyst, or of about 3 weight % of alkali metal per catalyst to about 5 weight % of alkali metal per catalyst, or of about 3.3 weight % of alkali metal per catalyst to about 4 weight % of alkali metal per catalyst.

In some embodiments of the present disclosure, the catalysts comprise gamma-alumina (γ-Al₂O₃) phase and about 5 weight % of potassium (K) per catalyst; and wherein the catalysts are in a form of a plurality of particles having an average particle size of about 200 micrometers to about 500 micrometers.

In some embodiments of the present disclosure, the catalysts comprise theta-alumina (θ-Al₂O₃) phase and about 1 weight % of potassium (K) per catalyst; and wherein the catalysts are in a form of a plurality of particles having an average particle size of about 200 micrometers to about 500 micrometers.

Synthesis of Catalysts: In various embodiments of the present disclosure, the catalysts may be synthesized by methods comprising: combining a solution comprising an alkali metal compound with alumina (Al₂O₃) to produce a homogeneous paste; drying the homogeneous paste at about 120° C. for at least about 24 hours; and calcining the homogeneous paste for at least about 1 hour at a calcining temperature of at least about 550° C. to produce the catalysts comprising the alkali metal and the alumina.

In some embodiments of the present disclosure, the catalysts may be synthesized by methods comprising: providing a solution, wherein the solution comprises an alkali metal compound; combining the solution with alumina (Al₂O₃) to produce a homogeneous paste; drying the homogeneous paste at about 120° C. for at least about 24 hours; and calcining the homogeneous paste for at least about 1 hour at a calcining temperature of at least about 550° C. to produce the catalysts, wherein the catalysts comprise the alkali metal and the alumina.

In some embodiments of the present disclosure, the catalysts may be synthesized by methods comprising: providing a solution, wherein the solution comprises an alkali metal compound; combining the solution with alumina (Al₂O₃) to produce a homogeneous paste; mixing the solution with alumina (Al₂O₃) to produce a homogeneous paste; drying the homogeneous paste at about 120° C. for at least about 24 hours; and calcining the homogeneous paste for at least about 1 hour at a calcining temperature of at least about 550° C. to produce the catalysts; the catalysts comprise: alumina (Al₂O₃) and an alkali metal in an amount of about 1 weight % to about 9.5 weight % per the catalyst; and the catalysts are in a form of a plurality of particles having an average particle size of about 200 micrometers to about 500 micrometers.

In some embodiments of the present disclosure, the catalysts may be synthesized by methods comprising: providing a solution, wherein the solution comprises an alkali metal compound; combining the solution with alumina (Al₂O₃) to produce a homogeneous paste; mixing the solution with alumina (Al₂O₃) to produce a homogeneous paste; drying the homogeneous paste at about 120° C. for at least about 24 hours; and calcining the homogeneous paste for at least about 1 hour at a calcining temperature of at least about 550° C. to produce the catalysts; the catalysts comprise: alumina (Al₂O₃) and an alkali metal in an amount of about 1 weight % to about 9.5 weight % per the catalyst; and the catalysts are in a form of a plurality of particles having an average particle size of about 200 micrometers to about 500 micrometers; and wherein the alkali metal is selected from the group consisting of lithium (Li), sodium (Na), potassium (K), cesium (caesium) (Cs), and any combination thereof.

In some embodiments of the present disclosure, the catalysts are synthesized by the methods above and the alumina is in a phase selected from the group consisting of alpha-alumina (α-Al₂O₃) phase, theta-alumina (θ-Al₂O₃) phase, gamma-alumina (γ-Al₂O₃) phase, and any combination thereof.

In some embodiments of the present disclosure, the catalysts may be synthesized by methods comprising: providing a solution, wherein the solution comprises an alkali metal compound; combining the solution with alumina (Al₂O₃) to produce a homogeneous paste; mixing the solution with alumina (Al₂O₃) to produce a homogeneous paste; drying the homogeneous paste at about 120° C. for at least about 24 hours; and calcining the homogeneous paste for at least about 1 hour at a calcining temperature of at least about 550° C. to produce the catalysts; the catalysts comprise: alumina in a phase selected from the group consisting of alpha-alumina (α-Al₂O₃) phase, theta-alumina (θ-Al₂O₃) phase, gamma-alumina (γ-Al₂O₃) phase, and any combination thereof; and an alkali metal in an amount of about 1 weight % to about 9.5 weight % per the catalyst; and the catalysts are in a form of a plurality of particles having an average particle size of about 200 micrometers to about 500 micrometers.

In some embodiments of the present disclosure, the catalysts may be synthesized by methods comprising: providing a solution, wherein the solution comprises an alkali metal compound; combining the solution with alumina (Al₂O₃) to produce a homogeneous paste; mixing the solution with alumina (Al₂O₃) to produce a homogeneous paste; drying the homogeneous paste at about 120° C. for at least about 24 hours; and calcining the homogeneous paste for at least about 1 hour at a calcining temperature of at least about 550° C. to produce the catalysts; the catalysts comprise: alumina in a phase selected from the group consisting of alpha-alumina (α-Al₂O₃) phase, theta-alumina (θ-Al₂O₃) phase, gamma-alumina (γ-Al₂O₃) phase, and any combination thereof; and an alkali metal in an amount of about 1 weight % to about 9.5 weight % per the catalyst; and the catalysts are in a form of a plurality of particles having an average particle size of about 200 micrometers to about 500 micrometers; and the alkali metal is selected from the group consisting of lithium (Li), sodium (Na), potassium (K), cesium (caesium) (Cs), and any combination thereof.

The alkali metal compound may comprise an alkali metal as described above.

The alumina may be as described above.

The solutions comprise at least one alkali metal compound. The solutions may be aqueous mixtures. Furthermore, the solutions may be aqueous mixtures, wherein the solvent is deionized water. Deionized water is demineralized water; deionized water is water that has had all or almost all of its minerals and mineral ions (both cations and anions) removed.

The combining of the alumina and the solution comprising the alkali metal compound may be performed using one or more known techniques. For example, the alkali metal compound may be introduced into the alumina by wetness impregnation. Furthermore, combining the solution with alumina (Al₂O₃) to produce a homogeneous paste may include mixing the solution with alumina (Al₂O₃) to produce a homogeneous paste.

The proportions of the solution comprising the alkali metal compound and the alumina may be varied in view of one or more of the combining technique(s), the desired final weight percentage of the alkali metal in the catalyst, and other parameters that will be apparent to the person of ordinary skill in the art having the benefit of the present disclosure.

Static air refers to air that is still (i.e., air that is not actively circulated); static air is stagnant. Forced air refers to air that is actively pushed or circulated by a fan or other mechanism; forced air is actively moving.

In some embodiments of the present disclosure, the catalysts are synthesized by the methods above and the calcining is performed at a calcining temperature of about 550° C. to about 750° C.

In some embodiments of the present disclosure, the catalysts may be synthesized by methods comprising: providing a solution, wherein the solution comprises an alkali metal compound; combining the solution with alumina (Al₂O₃) to produce a homogeneous paste; drying the homogeneous paste at about 120° C. for at least about 24 hours; and calcining the homogeneous paste for at least about 1 hour at a calcining temperature of about 550° C. to about to 750° C. to produce the catalysts, wherein the catalysts comprise the alkali metal and the alumina.

Calcining is thermal treatment of compounds whereby the compounds are raised to high calcining temperatures, generally for the purpose of removing impurities or volatile substances. Calcining may be performed either in the presence of oxygen or in the absence of oxygen. The calcining occurs for at least about 1 hour at a calcining temperature of at least about 550° C. Preferably, the calcining occurs for at least about 1 hour at a calcining temperature of about 550° C. to about 750° C. More preferably, the calcining occurs for about 5 hours at a calcining temperature of about 550° C. to about 750° C., or of about 560° C. to about 740° C., or of about 570° C. to about 730° C., or of about 580° C. to about 720° C., or of about 590° C. to about 710° C., or of about 600° C. to about 700° C., or of about 610° C. to about 690° C., or of about 620° C. to about 680° C., or of about 630° C. to about 670° C., or of about 640° C. to about 660° C., or of about 650° C. to about 655° C. Most preferably, the calcining occurs for about 5 hours at a calcining temperature of about 600° C.

In some embodiments of the present disclosure, the catalysts are synthesized by the methods above to produce catalysts comprising the γ-Al₂O₃ and about 5 weight % of the potassium (K) per catalyst; wherein the solution comprises a KHCO₃ aqueous solution; and wherein the calcining temperature is about 600° C. for about 5 hours under static air.

In some embodiments of the present disclosure, the catalysts may be synthesized by methods comprising: providing a solution, wherein the solution comprises a KHCO₃ aqueous solution; combining the solution with gamma-alumina (γ-Al₂O₃) to produce a homogeneous paste; drying the homogeneous paste at about 120° C. for at least about 24 hours; and calcining the homogeneous paste for about 5 hours at a calcining temperature of about 600° C. under static air to produce the catalysts, wherein the catalysts comprise the γ-Al₂O₃ and about 5 weight % of the potassium (K) per the catalyst.

In some embodiments of the present disclosure the catalysts are synthesized by the methods above to produce catalysts comprising the θ-Al₂O₃ and about 1 weight % of the potassium (K) per catalyst; wherein the solution comprises a KHCO₃ aqueous solution; and wherein the calcining temperature is about 600° C. for about 5 hours under static air.

In some embodiments of the present disclosure, the catalysts may be synthesized by methods comprising: providing a solution, wherein the solution comprises a KHCO₃ aqueous solution; combining the solution with theta-alumina (θ-Al₂O₃) to produce a homogeneous paste; drying the homogeneous paste at about 120° C. for at least about 24 hours; and calcining the homogeneous paste for about 5 hours at a calcining temperature of about 600° C. under static air to produce the catalysts, wherein the catalysts comprise the θ-Al₂O₃ and about 1 weight % of the potassium (K) per catalyst.

In some embodiments of the present disclosure, the catalysts are synthesized by the methods above, and then the catalysts undergo further processing to produce a plurality of particles having an average particle size of about 200 micrometers to about 500 micrometers.

The further processing of the catalysts encompasses granulating and/or pelleting to produce a plurality of particles having an average particle size of about 200 micrometers to about 500 micrometers. The granulating and/or pelleting of the catalysts may occur in any order. The granulating and/or pelleting may be performed multiple times (e.g., a first granulating, a second granulating, a first pelleting, a second pelleting, etc.) on the catalysts. Producing granules and particles in the micrometer range involves typical granulation methods that are known to ordinary persons skilled in the art. Examples of common granulation methods include wet granulation, dry granulation, spray drying, and milling.

In some embodiments of the present disclosure, the catalysts may be synthesized by methods comprising: providing a solution, wherein the solution comprises an alkali metal compound; combining the solution with alumina (Al₂O₃) to produce a homogeneous paste; drying the homogeneous paste at about 120° C. for at least about 24 hours; and calcining the homogeneous paste for at least about 1 hour at a calcining temperature of at least about 550° C. to produce the catalysts, wherein the catalysts comprise the alkali metal and the alumina; and then, granulating and/or pelleting the catalyst into a form of a plurality of particles having an average particle size of about 200 micrometers to about 500 micrometers. The granulating may occur once or multiple times. The pelleting may occur once or multiple times. The granulating and the pelleting may be performed in any order.

In some embodiments of the present disclosure, the catalysts may be synthesized by methods comprising: providing a solution, wherein the solution comprises an alkali metal compound; combining the solution with alumina (Al₂O₃) to produce a homogeneous paste; drying the homogeneous paste at about 120° C. for at least about 24 hours; and calcining the homogeneous paste for at least about 1 hour at a calcining temperature of at least about 550° C. to produce the catalysts. The catalysts may then undergo granulating and/or pelleting into a form of a plurality of particles having an average particle size of about 200 micrometers to about 500 micrometers. The catalysts may comprise alumina and an alkali metal; wherein the alumina is in a phase selected from the group consisting of alpha-alumina (α-Al₂O₃) phase, theta-alumina (θ-Al₂O₃) phase, gamma-alumina (γ-Al₂O₃) phase, and any combination thereof; and the alkali metal is in an amount of about 1 weight % to about 9.5 weight % per the catalyst.

In some embodiments of the present disclosure, the catalysts are synthesized by the methods above; and the alkali metal compound comprises an alkali metal selected from the group consisting of lithium (Li), sodium (Na), potassium (K), cesium (caesium) (Cs), and any combination thereof; and the alkali metal compound is selected from the group consisting of alkali metal nitrates, alkali metal chlorides, alkali metal carbonates, alkali metal bicarbonates (alkali metal hydrogencarbonates), alkali metal benzoates, alkali metal acetylacetonates, mono-alkali metal acetylides, di-alkali metal acetylides, alkali metal N-acetyl aminosuccinates, alkali metal acetates, and any combination thereof.

In some embodiments of the present disclosure, the catalysts may be synthesized by methods comprising: providing a solution, wherein the solution comprises an alkali metal compound; and wherein the alkali metal compound comprises an alkali metal selected from the group consisting of lithium (Li), sodium (Na), potassium (K), cesium (caesium) (Cs), and any combination thereof; and wherein the alkali metal compound is selected from the group consisting of alkali metal nitrates, alkali metal chlorides, alkali metal carbonates, alkali metal bicarbonates (alkali metal hydrogencarbonates), alkali metal benzoates, alkali metal acetylacetonates, mono-alkali metal acetylides, di-alkali metal acetylides, alkali metal N-acetyl aminosuccinates, alkali metal acetates, and any combination thereof; combining the solution with alumina (Al₂O₃) to produce a homogeneous paste; drying the homogeneous paste at about 120° C. for at least about 24 hours; and calcining the homogeneous paste for at least about 1 hour at a calcining temperature of at least about 550° C. to produce the catalysts, wherein the catalysts comprise the alkali metal and the alumina.

In some embodiments of the present disclosure, the catalysts may be synthesized by methods comprising: providing a solution, wherein the solution comprises an alkali metal compound; and wherein the alkali metal compound comprises an alkali metal selected from the group consisting of lithium (Li), sodium (Na), potassium (K), cesium (caesium) (Cs), and any combination thereof; and wherein the alkali metal compound is selected from the group consisting of alkali metal nitrates, alkali metal chlorides, alkali metal carbonates, alkali metal bicarbonates (alkali metal hydrogencarbonates), alkali metal benzoates, alkali metal acetylacetonates, mono-alkali metal acetylides, di-alkali metal acetylides, alkali metal N-acetyl aminosuccinates, alkali metal acetates, and any combination thereof; combining the solution with alumina (Al₂O₃) to produce a homogeneous paste, wherein the alumina is in a phase selected from the group consisting of alpha-alumina (a-Al₂O₃) phase, theta-alumina (θ-Al₂O₃) phase, gamma-alumina (γ-Al₂O₃) phase, and any combination thereof; mixing the solution with alumina (Al₂O₃) to produce a homogeneous paste; drying the homogeneous paste at about 120° C. for at least about 24 hours; and calcining the homogeneous paste for at least about 1 hour at a calcining temperature of at least about 550° C. to produce the catalysts, wherein the catalysts comprise alumina (Al₂O₃) and an alkali metal; and wherein the alkali metal is in an amount of about 1 weight % to about 9.5 weight % per the catalyst; and wherein the catalysts are in a form of a plurality of particles having an average particle size of about 200 micrometers to about 500 micrometers.

In some embodiments of the present disclosure, the catalysts may be synthesized by methods comprising: providing a solution, wherein the solution comprises an alkali metal compound; and wherein the alkali metal compound comprises an alkali metal selected from the group consisting of lithium (Li), sodium (Na), potassium (K), cesium (caesium) (Cs), and any combination thereof; and wherein the alkali metal compound is selected from the group consisting of alkali metal nitrates, alkali metal chlorides, alkali metal carbonates, alkali metal bicarbonates (alkali metal hydrogencarbonates), alkali metal benzoates, alkali metal acetylacetonates, mono-alkali metal acetylides, di-alkali metal acetylides, alkali metal N-acetyl aminosuccinates, alkali metal acetates, and any combination thereof; combining the solution with alumina (Al₂O₃) to produce a homogeneous paste; drying the homogeneous paste at about 120° C. for at least about 24 hours; and calcining the homogeneous paste for at least about 1 hour at a calcining temperature of at least about 550° C. to produce the catalysts, wherein the catalysts comprise the alkali metal and the alumina; and wherein the alumina is in a phase selected from the group consisting of alpha-alumina (α-Al₂O₃) phase, theta-alumina (θ-Al₂O₃) phase, gamma-alumina (γ-Al₂O₃) phase, and any combination thereof.

The addition of the alkali metal(s) that is to be introduced to the alumina (Al₂O₃) for the catalysts may originate from a variety of sources or compounds. Common suitable examples for the sources of alkali metals include, but are not limited to, alkali metal nitrates, alkali metal chlorides, alkali metal carbonates, alkali metal bicarbonates (alkali metal hydrogencarbonates), alkali metal benzoates, alkali metal acetylacetonates, mono-alkali metal acetylides, di-alkali metal acetylides, alkali metal N-acetyl aminosuccinates, alkali metal acetates, and any combination thereof.

Alkali metal nitrates (MNO₃) comprise at least one alkali metal and at least one nitrate (NO₃⁻) group. Suitable examples of alkali metal nitrates include, but are not limited to, lithium nitrate (LiNO₃), sodium nitrate (NaNO₃), potassium nitrate (KNO₃), rubidium nitrate (RbNO₃), cesium nitrate (caesium nitrate) (CsNO₃), and any combination thereof.

Alkali metal chlorides (MCl) comprise at least one alkali metal and at least one chloride anion (Cl⁻). Suitable examples of alkali metal chlorides include, but are not limited to, lithium chloride (LiCl), sodium chloride (NaCl), potassium chloride (KCl), rubidium chloride (RbCl), cesium chloride (caesium chloride) (CsCl), and any combination thereof.

Alkali metal carbonates (M₂CO₃) comprise at least one alkali metal and at least one carbonate (CO₃²⁻) group. Usually, alkali metal carbonates consist of two alkali metals and one carbonate group. Suitable examples of alkali metal carbonates include, but are not limited to, lithium carbonate (Li₂CO₃), sodium carbonate (Na₂CO₃), potassium carbonate (K₂CO₃), rubidium carbonate (Rb₂CO₃), cesium carbonate (caesium carbonate) (Cs₂CO₃), and any combination thereof.

Alkali metal bicarbonates (MHCO₃ or MCO₃H) are also known as alkali metal hydrogencarbonates, and they comprise at least one alkali metal and at least one bicarbonate (hydrogencarbonate) group (HCO₃⁻ or CO₃⁻H). Suitable examples of alkali metal bicarbonates (alkali metal hydrogencarbonates) include, but are not limited to, lithium bicarbonate (lithium hydrogencarbonate) (LiHCO₃ or LiCO₃H), sodium bicarbonate (sodium hydrogencarbonate) (NaHCO₃ or NaCO₃H), sodium sesquicarbonate (trisodium hydrogendicarbonate) (Na₃H(CO₃)₂ or Na₃(CO₃)₂H), potassium bicarbonate (potassium hydrogencarbonate) (KHCO₃ or KCO₃H), rubidium bicarbonate (rubidium hydrogencarbonate) (RbHCO₃ or RbCO₃H), cesium bicarbonate (cesium hydrogencarbonate) (caesium bicarbonate) (caesium hydrogencarbonate) (CsHCO₃ or CsCO₃H), and any combination thereof.

Alkali metal benzoates (PhCOOM) comprise at least one alkali metal and at least one benzoate (PhCOO⁻) functional group. Suitable examples of alkali metal benzoates include, but are not limited to, lithium benzoate (PhCOOLi), sodium benzoate (PhCOONa), potassium benzoate (PhCOOK), rubidium benzoate (PhCOORb), cesium benzoate (caesium benzoate) (PhCOOCs), and any combination thereof.

Alkali metal acetylacetonates (M(acac)) comprises at least one alkali metal and at least one acetylacetonate anion (acac⁻). Suitable examples of alkali metal acetylacetonates include, but are not limited to, lithium acetylacetonate (Li(acac)), sodium acetylacetonate (Na(acac)), potassium acetylacetonate (K(acac)), cesium acetylacetonate (caesium acetylacetonate) (Cs(acac)), and any combination thereof.

Alkali metal acetates (CH₃COOM) comprise at least one alkali metal and at least one acetate (CH₃COO⁻) functional group. Suitable examples of alkali metal acetates include, but are not limited to, lithium acetate (CH₃COOLi), sodium acetate (CH₃COONa), sodium diacetate (CH₃COONaHOOCCH₃), potassium acetate (CH₃COOK), rubidium acetate (CH₃COORb), cesium acetate (CH₃COOCs), and any combination thereof.

Lithium acetate (CH₃COOLi) is also known as lithium ethanoate. Sodium acetate (CH₃COONa) is also known as sodium ethanoate. Potassium acetate (CH₃COOK) is also known as potassium ethanoate. Rubidium acetate (CH₃COORb) is also known as rubidium ethanoate. Cesium acetate (CH₃COOCs) is also known as caesium acetate, cesium ethanoate, and caesium ethanoate.

There are a variety of ways to modify the surface of an absorbent to increase the affinity of the solute towards the absorbent. Suitable examples of methods for improving the absorbent capacity include, but are not limited to, chemical treatments, chemical grafting methods, the metal impregnation methods, and any combination thereof.

The purpose of the metal impregnation methods is to improve the absorbent capacity. There are two main techniques regarding the metal impregnation methods: the pore-volume impregnation methods or the wetness-impregnation methods. The pore-volume impregnation method is also known as the dry impregnation method because a limited amount of solvent is added so that the pores of the absorbent are just filled. The wetness-impregnation method uses excess amounts of solvent (more than the volume of the pores) which is added after filling the pores; then the excess chemical is dried, and the loading may be controlled.

Pre-reaction preparation of the catalysts: The previously synthesized catalysts may then be prepared for use. In various embodiments of the present disclosure, the previously synthesized catalysts were pressed at about 8 tones to form tablets which were crushed and sieved to form granules which have an average size of about 200 micrometers (μm) to about 500 micrometers. The granules (approximately 1.5 cm³, 0.5 g) were packed with silicon carbide (SiC) into tabular HASTELLOY® X fixed-bed reactors which are 310 mm in length and have a 9.1 mm internal diameter. The HASTELLOY® X fixed-bed reactors have a thermocouple (a thermoelectrical thermometer) immersed into the catalyst beds. Argon (Ar) gas, at a flow rate of approximately 75 cm³/min, was passed over the catalysts. The activation temperature of the HASTELLOY® X fixed-bed reactors was raised to at least about 650° C. at a rate of about 5° C./min to about 15° C./min.

Performing the reactions: Then the reverse water-gas shift (RWGS) reactions may be performed with the catalysts. In various embodiments of the present disclosure, with the previously prepared catalysts in HASTELLOY® X fixed-bed reactors, the temperature was raised to the selected temperature at a rate of 5° C./min. In various embodiments of the present disclosure, the continuous flow reactions ran over 0.5 g of the desired catalysts under the selected pressures. The continuous flow reactions were set to specific feed compositions, where the feed compositions of CO₂ to H₂ were in the range of about 1:1 to about 1:5. The feed composition contains only these two gases. Preferably, the reactions have Gas Hourly Space Velocity of about 3300 mL (grams of catalyst)⁻¹ hour⁻¹ to about 13200 mL (grams of catalyst)⁻¹ hour⁻¹. More preferably, the reactions have Gas Hourly Space Velocity of about 6600 mL (grams of catalyst)⁻¹ hour⁻¹. The reactions are performed at a reaction temperature of about 550° C. to about 900° C. More preferably, the reactions are performed at a reaction temperature of about 650° C. to about 900° C. Most preferably, the reactions are performed at a reaction temperature of about 750° C. The reactions are performed in pressure ranges of about atm to about 5 bar gauge (barg). More preferably, the reactions are performed at about atm.

The reactions are performed at a reaction temperature of about 550° C. to about 900° C., or of about 560° C. to about 890° C., or of about 570° C. to about 880° C., or of about 580° C. to about 870° C., or of about 590° C. to about 860° C., or of about 600° C. to about 850° C., or of about 610° C. to about 840° C., or of about 620° C. to about 830° C., or of about 630° C. to about 820° C., or of about 640° C. to about 810° C., or of about 650° C. to about 800° C., or of about 660° C. to about 790° C., or of about 670° C. to about 785° C., or of about 680° C. to about 780° C., or of about 690° C. to about 775° C., or of about 695° C. to about 770° C., or of about 700° C. to about 765° C., or of about 705° C. to about 760° C., or of about 710° C. to about 755° C., or of about 715° C. to about 750° C., or of about 720° C. to about 745° C., or of about 725° C. to about 740° C., or of about 730° C. to about 735° C.

In various embodiments of the present disclosure, batch reactions may be performed instead of continuous flow reactions. In various embodiments of the present disclosure, batch reactions may be performed as well as continuous flow reactions.

Performing the reverse water-gas shift (RWGS) reactions with catalysts comprising at least one alkali metal on alumina (Al₂O₃), under the above conditions provided for at least a 99% selectivity for the formation of carbon monoxide (CO) over the formation of methane (CH₄) from feed compositions of carbon dioxide (CO₂) gas and hydrogen (H₂) gas. Preferably, the amount of the alkali metal(s) on the alumina (Al₂O₃) comprises about 0.00001 weight % to about 9.5 weight % of the alkali metal(s) per the catalyst. Most preferably, the amount of the alkali metal(s) on the alumina (Al₂O₃) is at about 1 weight % of the alkali metal(s) per the catalyst to about 6 weight % of the alkali metal(s) per the catalyst.

For performing the reactions, the methods may comprise: introducing the catalysts into a chemical reactor, wherein the catalysts are described above; activating the catalysts by heating the catalysts to an activation temperature of at least about 650° C. at a rate of about 5° C./min to about 15° C./min under argon; flowing a feed composition at a Gas Hourly Space Velocity of about 3300 mL (grams of catalyst)⁻¹ hour⁻¹ to about 13,200 mL (grams of catalyst)⁻¹ hour⁻¹ into the chemical reactor, wherein the feed composition comprises CO₂ and H₂; maintaining the chemical reactor at a reaction temperature of about 550° C. to about 900° C. and at a pressure of about atmospheric pressure to about 5 bar gauge (barg); and recovering a first mixture stream leaving the chemical reactor, wherein the first mixture stream comprises: water (H₂O) vapor, unreacted carbon dioxide (CO₂) gas, unreacted hydrogen (H₂) gas, and carbon monoxide (CO) gas.

In various embodiments of the present disclosure, one nonlimiting product from the reverse water-gas shift (RWGS) reactions is a first mixture stream comprising carbon monoxide (CO) gas, water (H₂O) vapor, unreacted carbon dioxide (CO₂) gas, and unreacted hydrogen (H₂) gas. The unreacted carbon dioxide (CO₂) gas is the same as the carbon dioxide (CO₂) gas from the feed composition. The unreacted hydrogen (H₂) gas is the same as the hydrogen (H₂) gas from the feed composition.

The flowing of the feed compositions for the reactions may have a Gas Hourly Space Velocity of about 3300 mL (grams of catalyst)⁻¹ hour⁻¹ to about 13200 mL (grams of catalyst)⁻¹ hour⁻¹, or of about 3350 mL (grams of catalyst)⁻¹ hour⁻¹ to about 13100 mL (grams of catalyst)⁻¹ hour⁻¹, or of about 3400 mL (grams of catalyst)⁻¹ hour⁻¹ to about 13000 mL (grams of catalyst)⁻¹ hour⁻¹, or of about 3450 mL (grams of catalyst)⁻¹ hour⁻¹ to about 12900 mL (grams of catalyst)⁻¹ hour⁻¹, or of about 3500 mL (grams of catalyst)⁻¹ hour⁻¹ to about 12800 mL (grams of catalyst)⁻¹ hour⁻¹, or of about 3550 mL (grams of catalyst)⁻¹ hour⁻¹ to about 12700 mL (grams of catalyst)⁻¹ hour⁻¹, or of about 3600 mL (grams of catalyst)⁻¹ hour⁻¹ to about 12600 mL (grams of catalyst) 1 hour⁻¹, or of about 3650 mL (grams of catalyst)⁻¹ hour⁻¹ to about 12500 mL (grams of catalyst)⁻¹ hour⁻¹, or of about 3700 mL (grams of catalyst)⁻¹ hour 1 to about 12400 mL (grams of catalyst)⁻¹ hour⁻¹, or of about 3750 mL (grams of catalyst)⁻¹ hour⁻¹ to about 12300 mL (grams of catalyst)⁻¹ hour⁻¹, or of about 3800 mL (grams of catalyst)⁻¹ hour 1 to about 12200 mL (grams of catalyst)⁻¹ hour⁻¹, or of about 3850 mL (grams of catalyst)⁻¹ hour⁻¹ to about 12100 mL (grams of catalyst)⁻¹ hour⁻¹, or of about 3900 mL (grams of catalyst)⁻¹ hour⁻¹ to about 12000 mL (grams of catalyst)⁻¹ hour⁻¹, or of about 3950 mL (grams of catalyst)⁻¹ hour⁻¹ to about 11900 mL (grams of catalyst)⁻¹ hour⁻¹, or of about 4000 mL (grams of catalyst)⁻¹ hour⁻¹ to about 11800 mL (grams of catalyst)⁻¹ hour⁻¹, or of about 4050 mL (grams of catalyst)⁻¹ hour⁻¹ to about 11700 mL (grams of catalyst)⁻¹ hour⁻¹, or of about 4100 mL (grams of catalyst)⁻¹ hour⁻¹ to about 11600 mL (grams of catalyst)⁻¹ hour⁻¹, or of about 4150 mL (grams of catalyst)⁻¹ hour⁻¹ to about 11500 mL (grams of catalyst)⁻¹ hour⁻¹, or of about 4200 mL (grams of catalyst)⁻¹ hour⁻¹ to about 11400 mL (grams of catalyst)⁻¹ hour⁻¹, or of about 4250 mL (grams of catalyst)⁻¹ hour⁻¹ to about 11300 mL (grams of catalyst)⁻¹ hour⁻¹, or of about 4300 mL (grams of catalyst)⁻¹ hour⁻¹ to about 11200 mL (grams of catalyst)⁻¹ hour⁻¹, or of about 4350 mL (grams of catalyst)⁻¹ hour⁻¹ to about 11100 mL (grams of catalyst)⁻¹ hour⁻¹, or of about 4400 mL (grams of catalyst)⁻¹ hour⁻¹ to about 11000 mL (grams of catalyst)⁻¹ hour⁻¹, or of about 4450 mL (grams of catalyst)⁻¹ hour⁻¹ to about 10900 mL (grams of catalyst)⁻¹ hour⁻¹, or of about 4500 mL (grams of catalyst)⁻¹ hour⁻¹ to about 10800 mL (grams of catalyst)⁻¹ hour⁻¹, or of about 4550 mL (grams of catalyst)⁻¹ hour⁻¹ to about 10700 mL (grams of catalyst)⁻¹ hour⁻¹, or of about 4600 mL (grams of catalyst)⁻¹ hour⁻¹ to about 10600 mL (grams of catalyst)⁻¹ hour⁻¹, or of about 4650 mL (grams of catalyst)⁻¹ hour⁻¹ to about 10500 mL (grams of catalyst)⁻¹ hour⁻¹, or of about 4700 mL (grams of catalyst)⁻¹ hour⁻¹ to about 10400 mL (grams of catalyst)⁻¹ hour⁻¹, or of about 4750 mL (grams of catalyst)⁻¹ hour⁻¹ to about 10300 mL (grams of catalyst)⁻¹ hour⁻¹, or of about 4800 mL (grams of catalyst)⁻¹ hour⁻¹ to about 10200 mL (grams of catalyst)⁻¹ hour⁻¹, or of about 4850 mL (grams of catalyst)⁻¹ hour⁻¹ to about 10100 mL (grams of catalyst)⁻¹ hour⁻¹, or of about 4900 mL (grams of catalyst)⁻¹ hour⁻¹ to about 10000 mL (grams of catalyst)⁻¹ hour⁻¹, or of about 4950 mL (grams of catalyst)⁻¹ hour⁻¹ to about 9900 mL (grams of catalyst)⁻¹ hour⁻¹, or of about 5000 mL (grams of catalyst)⁻¹ hour⁻¹ to about 9800 mL (grams of catalyst)⁻¹ hour 1, or of about 5050 mL (grams of catalyst)⁻¹ hour⁻¹ to about 9700 mL (grams of catalyst)⁻¹ hour 1, or of about 5100 mL (grams of catalyst)⁻¹ hour⁻¹ to about 9600 mL (grams of catalyst) 1 hour 1, or of about 5150 mL (grams of catalyst)⁻¹ hour⁻¹ to about 9500 mL (grams of catalyst)⁻¹ hour⁻¹, or of about 5200 mL (grams of catalyst)⁻¹ hour⁻¹ to about 9400 mL (grams of catalyst) 1 hour 1, or of about 5250 mL (grams of catalyst)⁻¹ hour⁻¹ to about 9300 mL (grams of catalyst)⁻¹ hour⁻¹, or of about 5300 mL (grams of catalyst)⁻¹ hour⁻¹ to about 9200 mL (grams of catalyst)⁻¹ hour⁻¹, or of about 5350 mL (grams of catalyst)⁻¹ hour⁻¹ to about 9100 mL (grams of catalyst)⁻¹ hour⁻¹, or of about 5400 mL (grams of catalyst)⁻¹ hour⁻¹ to about 9000 mL (grams of catalyst)⁻¹ hour⁻¹, or of about 5450 mL (grams of catalyst)⁻¹ hour⁻¹ to about 8900 mL (grams of catalyst)⁻¹ hour⁻¹, or of about 5500 mL (grams of catalyst)⁻¹ hour⁻¹ to about 8700 mL (grams of catalyst)⁻¹ hour⁻¹, or of about 5550 mL (grams of catalyst)⁻¹ hour⁻¹ to about 8600 mL (grams of catalyst)⁻¹ hour 1, or of about 5600 mL (grams of catalyst)⁻¹ hour⁻¹ to about 8500 mL (grams of catalyst) 1 hour 1, or of about 5650 mL (grams of catalyst)⁻¹ hour⁻¹ to about 8400 mL (grams of catalyst) 1 hour 1, or of about 5700 mL (grams of catalyst)⁻¹ hour⁻¹ to about 8300 mL (grams of catalyst)⁻¹ hour 1, or of about 5750 mL (grams of catalyst)⁻¹ hour⁻¹ to about 8200 mL (grams of catalyst) 1 hour 1, or of about 5800 mL (grams of catalyst)⁻¹ hour⁻¹ to about 8100 mL (grams of catalyst)⁻¹ hour⁻¹, or of about 5850 mL (grams of catalyst)⁻¹ hour⁻¹ to about 8000 mL (grams of catalyst)⁻¹ hour⁻¹, or of about 5900 mL (grams of catalyst)⁻¹ hour⁻¹ to about 7900 mL (grams of catalyst)⁻¹ hour⁻¹, or of about 5950 mL (grams of catalyst)⁻¹ hour⁻¹ to about 7800 mL (grams of catalyst)⁻¹ hour⁻¹, or of about 6000 mL (grams of catalyst)⁻¹ hour⁻¹ to about 7700 mL (grams of catalyst)⁻¹ hour⁻¹, or of about 6050 mL (grams of catalyst)⁻¹ hour⁻¹ to about 7600 mL (grams of catalyst)⁻¹ hour⁻¹, or of about 6100 mL (grams of catalyst)⁻¹ hour⁻¹ to about 7500 mL (grams of catalyst)⁻¹ hour⁻¹, or of about 6150 mL (grams of catalyst)⁻¹ hour⁻¹ to about 7400 mL (grams of catalyst) 1 hour 1, or of about 6200 mL (grams of catalyst)⁻¹ hour⁻¹ to about 7300 mL (grams of catalyst)⁻¹ hour⁻¹, or of about 6250 mL (grams of catalyst)⁻¹ hour⁻¹ to about 7200 mL (grams of catalyst) 1 hour 1, or of about 6300 mL (grams of catalyst)⁻¹ hour⁻¹ to about 7100 mL (grams of catalyst) 1 hour 1, or of about 6350 mL (grams of catalyst)⁻¹ hour⁻¹ to about 7000 mL (grams of catalyst) 1 hour 1, or of about 6400 mL (grams of catalyst)⁻¹ hour⁻¹ to about 6900 mL (grams of catalyst)⁻¹ hour 1, or of about 6450 mL (grams of catalyst)⁻¹ hour⁻¹ to about 6800 mL (grams of catalyst)⁻¹ hour⁻¹, or of about 6500 mL (grams of catalyst)⁻¹ hour⁻¹ to about 6700 mL (grams of catalyst)⁻¹ hour⁻¹, or of about 6550 mL (grams of catalyst)⁻¹ hour⁻¹ to about 6600 mL (grams of catalyst)⁻¹ hour⁻¹.

The reactions can be performed without pressure (i.e., at atm). However, the reactions may be pressurized; when applying pressure to the reaction chambers, the pressure for the reactions may be of about 0.3 barg to about 5 barg, or of about 0.4 barg to about 4.9 barg, or of about 0.5 barg to about 4.8 barg, or of about 0.6 barg to about 4.7 barg, or of about 0.7 barg to about 4.6 barg, or of about 0.8 barg to about 4.5 barg, or of about 0.9 barg to about 4.4 barg, or of about 1 barg to about 4.3 barg, or of about 1.1 barg to about 4.2 barg, or of about 1.2 barg to about 4.1 barg, or of about 1.3 barg to about 4 barg, or of about 1.4 barg to about 3.9 barg, or of about 1.5 barg to about 3.8 barg, or of about 1.6 barg to about 3.7 barg, or of about 1.7 barg to about 3.6 barg, or of about 1.8 barg to about 3.5 barg, or of about 1.9 barg to about 3.4 barg, or of about 2 barg to about 3.3 barg, or of about 2.1 barg to about 3.2 barg, or of about 2.2 barg to about 3.1 barg, or of about 2.3 barg to about 3 barg, or of about 2.4 barg to about 2.9 barg, or of about 2.5 barg to about 2.8 barg, or of about 2.6 barg to about 2.7 barg.

For performing the reactions, the methods may comprise: introducing the catalysts into a chemical reactor, wherein the catalysts are described above; flowing a feed composition at a Gas Hourly Space Velocity of about 3300 mL (grams of catalyst)⁻¹ hour⁻¹ to about 13,200 mL (grams of catalyst)⁻¹ hour⁻¹ into the chemical reactor, wherein the feed composition comprises CO₂ and H₂ in a ratio (CO₂:H₂) of about 1:1 to about 1:5; maintaining the chemical reactor at a reaction temperature of about 550° C. to about 900° C. and at a pressure of about atmospheric pressure to about 5 bar gauge (barg); and recovering a first mixture stream leaving the chemical reactor, wherein the first mixture stream comprises: water (H₂O) vapor, unreacted carbon dioxide (CO₂) gas, unreacted hydrogen (H₂) gas, and carbon monoxide (CO) gas.

The feed compositions of carbon dioxide (CO₂) gas to hydrogen (H₂) gas for the reactions are in ratios (CO₂:H₂) of about 1:1 to about 1:5, or of about 1:2 to about 1:4, or of about 1:2.5 to about 1:3.

For performing the reactions, the methods are described above, and the methods may further comprise: removing the water (H₂O) vapor from the first mixture stream to generate a second mixture stream, wherein the second mixture stream comprises: the carbon monoxide (CO) gas from the first mixture stream, the unreacted carbon dioxide (CO₂) gas from the first mixture stream, and the unreacted hydrogen (H₂) gas from the first mixture stream.

In various embodiments of the present disclosure, the water vapor from the first mixture stream may be removed. One nonlimiting example of removing the water vapor from the first mixture stream is by condensation in a condenser operating at about 0° C. to about 5° C.; this produces a second mixture stream. The second mixture stream comprises the carbon monoxide (CO) gas from the first mixture stream, the unreacted carbon dioxide (CO₂) gas from the first mixture stream, and the unreacted hydrogen (H₂) gas from the first mixture stream.

For performing the reactions, the methods are described above, and the methods may further comprise: recovering the unreacted carbon dioxide (CO₂) from the second mixture stream to form a syngas mixture stream; and then optionally, utilizing the syngas mixture stream; wherein the syngas mixture stream comprises the carbon monoxide (CO) gas from the second mixture stream and the unreacted hydrogen (H₂) gas from the second mixture stream.

In various embodiments of the present disclosure, the unreacted carbon dioxide (CO₂) gas may be recovered from the second mixture stream; this produces a syngas mixture stream. The syngas mixture stream comprises the carbon monoxide (CO) gas from the second mixture stream, and the unreacted hydrogen (H₂) gas from the second mixture stream. If desired, the syngas mixture stream may be utilized in a manufacturing process.

For nonlimiting suitable examples of utilizing syngas to make syngas-derived products, see U.S. Pat. App. Pub. Nos. 2009/0170968 A1 and 2022/0212924 A1 and see U.S. Pat. No. 8,123,827, the disclosures of each of which are hereby incorporated by reference in their entirety.

For performing the reactions, the methods are described above, and the methods may further comprise: recovering the unreacted hydrogen (H₂) gas from the syngas mixture stream to produce a first stream of carbon monoxide; and then optionally, utilizing the first stream of carbon monoxide; wherein the first stream of carbon monoxide comprises the carbon monoxide (CO) gas from the syngas mixture stream.

In various embodiments of the present disclosure, the unreacted hydrogen (H₂) gas from the syngas mixture stream may be recovered; this produces a first stream of carbon monoxide comprising the carbon monoxide (CO) gas. The carbon monoxide in the first stream of carbon monoxide may be utilized in a manufacturing process. Suitable examples of the applications of carbon monoxide include, but are not limited to, use as a fuel, use in the synthesis of compounds, use as a reducing agent, and any combination thereof.

For nonlimiting suitable examples of removing hydrogen (H₂) gas from syngas, see U.S. Pat. No. 10,160,704, the disclosure of which is hereby incorporated by reference in its entirety.

For performing the reactions, the methods may comprise: introducing the catalysts into a chemical reactor, wherein the catalysts are described above; activating the catalysts by heating the catalysts to an activation temperature of at least about 650° C. at a rate of about 5° C./min to about 15° C./min under argon; flowing a feed composition at a Gas Hourly Space Velocity of about 3300 mL (grams of catalyst)⁻¹ hour⁻¹ to about 13,200 mL (grams of catalyst)⁻¹ hour⁻¹ into the chemical reactor, wherein the feed composition comprises CO₂ and H₂; maintaining the chemical reactor at a reaction temperature of about 550° C. to about 900° C. and at a pressure of about atmospheric pressure to about 5 bar gauge (barg); and recovering a first mixture stream leaving the chemical reactor, wherein the first mixture stream comprises: water (H₂O) vapor, unreacted carbon dioxide (CO₂) gas, unreacted hydrogen (H₂) gas, and carbon monoxide (CO) gas; the methods may further comprise removing the water (H₂O) vapor from the first mixture stream to generate a second mixture stream, wherein the second mixture stream comprises: the carbon monoxide (CO) gas from the first mixture stream, the unreacted carbon dioxide (CO₂) gas from the first mixture stream, and the unreacted hydrogen (H₂) gas from the first mixture stream; the methods may further comprise recovering the unreacted hydrogen (H₂) gas from the second mixture stream to generate a third mixture stream, wherein the third mixture stream comprises the carbon monoxide (CO) gas from the second mixture stream and the unreacted carbon dioxide (CO₂) gas from the second mixture stream.

In various embodiments of the present disclosure, the unreacted hydrogen (H₂) gas may be recovered from the second mixture stream; this produces a third mixture stream comprising carbon monoxide (CO) gas from the second mixture stream and the unreacted carbon dioxide (CO₂) gas from second mixture stream.

For performing the reactions, the methods are described above, and the methods may further comprise: recovering the unreacted carbon dioxide (CO₂) from the third mixture stream to form a second stream of carbon monoxide; and then optionally, utilizing the second stream of carbon monoxide; wherein the second stream of carbon monoxide comprises the carbon monoxide (CO) gas from the third mixture stream.

In various embodiments of the present disclosure, the unreacted carbon dioxide (CO₂) gas from the third mixture stream may be recovered; this produces a second stream of carbon monoxide comprising the carbon monoxide (CO) gas from the third mixture stream. The carbon monoxide in the second stream of carbon monoxide may be utilized in a manufacturing process. Suitable examples of applications of carbon monoxide include, but are not limited to, use as a fuel, use in the synthesis of compounds, use as a reducing agent, and any combination thereof.

For performing the reactions, the methods are described above, and the methods may further comprise: maintaining the chemical reactor at a reaction temperature of about 700° C. to about 900° C.

For performing the reactions, the methods are described above, and the methods may further comprise: the chemical reactor is a fixed-bed reactor.

There are a variety of types of chemical reactors. Suitable examples of chemical reactors include, but are not limited to, fixed-bed reactors, trickle-bed reactors, moving bed reactors, rotating bed reactors, fluidized bed reactors, slurry reactors, and any combination thereof.

For performing the reactions, the methods may comprise: introducing the catalysts into a fixed-bed reactor, wherein the catalysts comprise the γ-Al₂O₃ and about 5 weight % of the potassium (K) per the catalyst; flowing a feed composition at a Gas Hourly Space Velocity of about 6600 mL (grams of catalyst)⁻¹ hour⁻¹ into the fixed-bed reactor, wherein the feed composition comprises CO₂ and H₂ in a ratio (CO₂:H₂) of about 1:1 to about 1:5; maintaining the fixed-bed reactor at a reaction temperature of about 750° C. and at a pressure of about atmospheric pressure; and recovering a first mixture stream leaving the chemical reactor, wherein the first mixture stream comprises: water (H₂O) vapor, unreacted carbon dioxide (CO₂) gas, unreacted hydrogen (H₂) gas, and carbon monoxide (CO) gas. For performing the reactions, the methods are described above, and the methods may further comprise: the catalysts comprising the γ-Al₂O₃ and about 5 weight % of the potassium (K) per the catalyst in a fixed-bed reactor; wherein the feed composition has a CO₂:H₂ ratio of about 1:1 to about 1:5; wherein the reaction temperature is about 750° C., the pressure is about atmospheric pressure; and wherein the Gas Hourly Space Velocity is about 6600 mL (grams of catalyst)⁻¹ hour⁻¹.

For performing the reactions, the methods may comprise: introducing the catalysts into a fixed-bed reactor, wherein the catalysts comprise the θ-Al₂O₃ and about 1 weight % of the potassium (K) per the catalyst; flowing a feed composition at a Gas Hourly Space Velocity of about 6600 mL (grams of catalyst)⁻¹ hour⁻¹ into the fixed-bed reactor, wherein the feed composition comprises CO₂ and H₂ in a ratio (CO₂:H₂) of about 1:1; maintaining the fixed-bed reactor at a reaction temperature of about 750° C. and at a pressure of about atmospheric pressure; and recovering a first mixture stream leaving the chemical reactor, wherein the first mixture stream comprises: water (H₂O) vapor, unreacted carbon dioxide (CO₂) gas, unreacted hydrogen (H₂) gas, and carbon monoxide (CO) gas. For performing the reactions, the methods are described above, and the methods may further comprise: the catalysts comprising the θ-Al₂O₃ and about 1 weight % of the potassium (K) per the catalyst in the fixed-bed reactor; wherein the feed composition has a CO₂:H₂ ratio of about 1:1, wherein the reaction temperature is about 750° C.; the pressure is about atmospheric pressure; and wherein the Gas Hourly Space Velocity is about 6600 mL (grams of catalyst)⁻¹ hour⁻¹.

Formation of Carbon Monoxide (CO) over Methane (CH₄) Selectivity. Reverse water-gas shift reactions catalyzed by the catalysts described herein may have a selectivity for the formation of carbon monoxide (CO) over the formation of methane (CH₄) of at least about 95%, or of at least about 96%, or of at least about 97%, or of at least about 98%, or of at least about 99%, or of at least about 99.990%, or of at least about 99.991%, or of at least about 99.992%, or of at least about 99.993%, or of at least about 99.994%, or of at least about 99.995%, or of at least about 99.996%, or of at least about 99.997%, or of at least about 99.998%, or of at least about 99.999%.

Selectivity for the Conversion of Carbon Dioxide (CO₂) to Carbon Monoxide (CO). Reverse water-gas shift reactions catalyzed by the catalysts described herein may have a selectivity for the conversion of carbon dioxide (CO) gas to carbon monoxide gas of at least about 60.83%, or of at least about 64.58%, or of at least about 70.06%, or of at least about 71.04%, or of at least about 71.21%, or of at least about 71.47%, or of at least about 71.53%, or of at least about 72.02%, or of at least about 72.18%, or of at least about 72.97%, or of at least about 73.92%, or of at least about 74.57%, or of at least about 74.68%, or of at least about 74.83%, or of at least about 74.90%, or of at least about 74.92%, or of at least about 74.98%, or of at least about 75.00%, or of at least about 75.38%, or of at least about 75.43%, or of at least about 75.46%, or of at least about 76.07%, or of at least about 76.10%, or of at least about 77.67%, or of at least about 77.76%, or of at least about 78.59%, or of at least about 78.63%, or of at least about 78.67%, or of at least about 79.11%, or of at least about 82.65%.

### Chemical Reactor Application of Catalysts

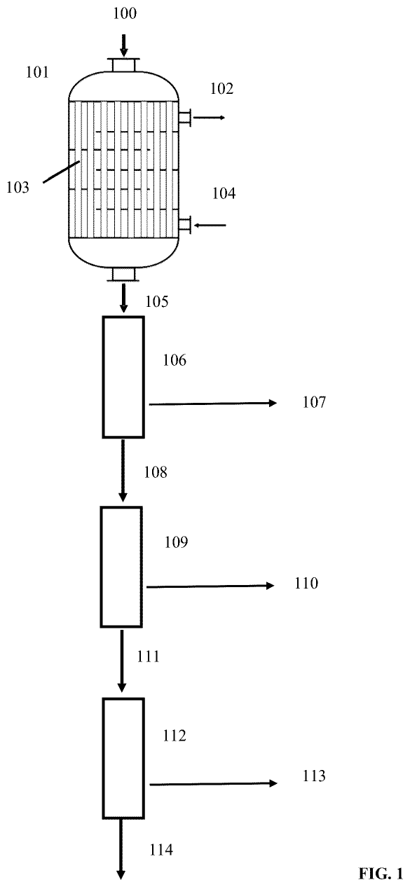

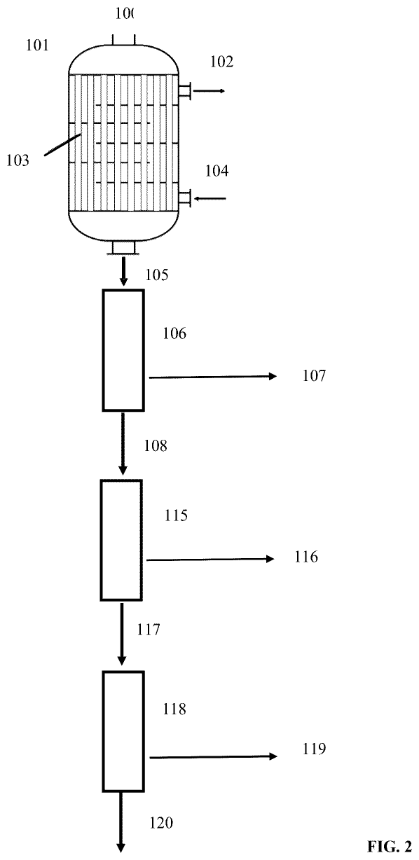

In various embodiments of the present disclosure, as shown in FIG. 1 and FIG. 2, the feed composition flows in the feed composition pipe 100 into the chemical reactor 101. The catalysts are placed into the catalyst bed 103 within the chemical reactor 101. Heat flows into 104 pipe of the chemical reactor and then out of 102 pipe of the chemical reactor. The reactions produce the first mixture stream which flows in the first mixture stream pipe 105. The first mixture stream comprises water (H₂O) vapor, unreacted carbon dioxide (CO₂) gas, unreacted hydrogen (H₂) gas, and the carbon monoxide (CO) gas.

In various embodiments of the present disclosure, as shown in FIG. 1, there is the option of removing the water from the first mixture stream flowing in the first mixture stream pipe 105. Optionally, the water is removed in the condenser 106 by condensation; the condenser 106 may operate at about 0° C. to about 5° C. The removal of water from the first mixture stream in the condenser 106 produces both a water stream flowing in the water stream pipe 107 and the second mixture stream flowing in the second mixture stream pipe 108. The second mixture stream comprises carbon monoxide (CO) gas from the first mixture stream, the unreacted carbon dioxide (CO₂) gas from the first mixture stream, and the unreacted hydrogen (H₂) gas from the first mixture stream.

In various embodiments of the present disclosure, as shown in FIG. 1, there is the option of removing the unreacted carbon dioxide (CO₂) from the second mixture stream flowing in the second mixture stream pipe 108. Optionally, the unreacted carbon dioxide (CO₂) from the second mixture stream is separated by the first distillation apparatus 109 performing cryogenic distillation. This produces both the first carbon dioxide (CO₂) stream flowing in the first carbon dioxide (CO₂) stream pipe 110 and the syngas mixture stream flowing in the syngas mixture stream pipe 111. The syngas mixture stream comprises the carbon monoxide (CO) gas from the second mixture stream and the unreacted hydrogen (H₂) gas from the second mixture stream. Optionally, the unreacted hydrogen (H₂) gas from the syngas mixture stream flowing in the syngas mixture stream pipe 111 is separated by the second distillation apparatus 112 performing cryogenic distillation. This produces both the first hydrogen (H₂) gas stream flowing in the first hydrogen (H₂) gas stream pipe 113 and the first stream of carbon monoxide (CO) gas flowing in the first stream of carbon monoxide (CO) gas pipe 114. The first stream of carbon monoxide comprises the carbon monoxide (CO) gas from the syngas mixture.

In various embodiments of the present disclosure, as shown in FIG. 2, there is the option of separating the unreacted hydrogen (H₂) gas from the second mixture stream flowing in second mixture stream pipe 108. Optionally, the unreacted hydrogen (H₂) gas from the second mixture stream is separated by second distillation apparatus 115 performing cryogenic distillation. This produces both a second hydrogen (H₂) gas stream flowing in second hydrogen (H₂) gas stream pipe 116 and a third mixture stream flowing in the third mixture stream pipe 117. The third mixture stream comprises the carbon monoxide (CO) gas from the first mixture stream and the unreacted carbon dioxide (CO₂) gas from the first mixture stream. Optionally, the unreacted carbon dioxide (CO₂) gas in the third mixture stream flowing in the third mixture stream pipe 117 is separated by the third distillation apparatus 118 performing cryogenic distillation. This produces both the second carbon dioxide (CO₂) stream flowing in second carbon dioxide (CO₂) stream pipe 119 and the second stream of carbon monoxide (CO) gas flowing in the second stream of carbon monoxide (CO) gas pipe 120.

### Examples—Reagents and Catalysts Tested

Reagent-1 (γ-Al₂O₃) 10 g gamma-alumina (γ-Al₂O₃) powder with a specific surface area of 206 m²/g and a pore volume of 0.362 cm³/g were calcined at 600° C. for 5 hours under static air.

Synthesis of Catalyst-2 (γ-Al₂O₃ and 1 weight % K per catalyst) 10 g of gamma-alumina (γ-Al₂O₃) powder with a specific surface area of 206 m²/g and a pore volume of 0.362 cm³/g were loaded with 1 weight % potassium (K) using wetness-impregnation. 0.261 g KHCO₃ dissolved in 4.5 mL deionized water was added to the solid γ-Al₂O₃ at once, and then mixed until a homogenous paste was obtained. The homogenous paste was dried at 120° C. for 24 hours. The dried sample was calcined at 600° C. for 5 hours under static air. The resulting catalyst comprises γ-Al₂O₃ and 1 weight % K per catalyst, and the resulting catalyst has a specific surface area of 206 m²/g and a pore volume of 0.364 cm³/g.

Synthesis of Catalyst-3 (γ-Al₂O₃ and 3 weight % K per catalyst) 10 g of gamma-alumina (γ-Al₂O₃) powder with a specific surface area of 206 m²/g and a pore volume of 0.362 cm³/g were loaded with 3 weight % potassium (K) using wetness-impregnation. 0.792 g KHCO₃ dissolved in 4.5 mL deionized water was added to the solid γ-Al₂O₃ at once, and then mixed until a homogenous paste was obtained. The homogenous paste was dried at 120° C. for 24 hours. The dried sample was calcined at 600° C. for 5 hours under static air. The resulting catalyst comprises γ-Al₂O₃ and 3 weight % K per catalyst, and the resulting catalyst has a specific surface area of 202 m²/g and a pore volume of 0.344 cm³/g.

Synthesis of Catalyst-4 (γ-Al₂O₃ and 5 weight % K per catalyst) 10 g of gamma-alumina (γ-Al₂O₃) powder with a specific surface area of 206 m²/g and a pore volume of 0.362 cm³/g were loaded with 5 weight % potassium (K) using wetness-impregnation. 6.73 mL of 2 Molar KHCO₃ aqueous solution was added to the solid γ-Al₂O₃ at once, and then mixed until a homogenous paste was obtained. The homogenous paste was dried at 120° C. for 24 hours. The dried sample was calcined at 600° C. for 5 hours under static air. The resulting catalyst comprises γ-Al₂O₃ and 5 weight % K per catalyst, and the resulting catalyst has a specific surface area of 184 m²/g and a pore volume of 0.337 cm³/g.

Synthesis of Reagent-5 (θ-Al₂O₃) Gamma-alumina (γ-Al₂O₃) powder has a specific surface area of 206 m²/g and a pore volume of 0.362 cm³/g. 50 g of gamma-alumina (γ-Al₂O₃) powder were calcined at 950° C. for 18 hours under static air to produce theta-alumina (θ-Al₂O₃) powder. The theta-alumina (θ-Al₂O₃) powder product has a specific surface area of 110 m²/g and a pore volume of 0.286 cm³/g.

Synthesis of Catalyst-6 (θ-Al₂O₃ and 1 weight % K per catalyst) 10 g of theta-alumina (θ-Al₂O₃) powder with a specific surface area of 110 m²/g and a pore volume of 0.286 cm³/g were loaded with 1 weight % potassium (K) using wetness-impregnation. 5.17 mL of 0.5 Molar KHCO₃ aqueous solution was added to the solid θ-Al₂O₃ at once, and then mixed until a homogenous paste was obtained. The homogenous paste was dried at 120° C. for 24 hours. The dried sample was calcined at 600° C. for 5 hours under static air. The resulting catalyst comprises θ-Al₂O₃ and 1 weight % K per catalyst, and the resulting catalyst has a specific surface area of 109 m²/g and a pore volume of 0.282 cm³/g.

Synthesis of Catalyst-7 (θ-Al₂O₃ and 3 weight % K per catalyst) 10 g of theta-alumina (θ-Al₂O₃) powder (fine powder) with a specific surface area of 110 m²/g and a pore volume of 0.286 cm³/g were loaded with 3 weight % potassium (K) using wetness-impregnation. 3.96 mL of 2 Molar KHCO₃ aqueous solution was added to the solid θ-Al₂O₃ at once, and then mixed until a homogenous paste was obtained. The homogenous paste was dried at 120° C. for 24 hours. The dried sample was calcined at 600° C. for 5 hours under static air. The resulting catalyst comprises θ-Al₂O₃ and 3 weight % K per catalyst, and the resulting catalyst has a specific surface area of 105 m²/g and a pore volume of 0.265 cm³/g.

Synthesis of Catalyst-8 (θ-Al₂O₃ and 5 weight % K per catalyst) 10 g of theta-alumina (θ-Al₂O₃) powder with a specific surface area of 110 m²/g and a pore volume of 0.286 cm³/g were loaded with 5 weight % potassium (K) using wetness-impregnation. 6.73 mL of 2 Molar KHCO₃ aqueous solution was added to the solid θ-Al₂O₃ at once, and then mixed until a homogenous paste was obtained. The homogenous paste was dried at 120° C. for 24 hours. The dried sample was calcined at 600° C. for 5 hours under static air. The resulting catalyst comprises θ-Al₂O₃ and 5 weight % K per catalyst, and the resulting catalyst has a specific surface area of 101 m²/g and a pore volume of 0.247 cm³/g.

Reagent-9 (α-Al₂O₃) 10 g of alpha-alumina (α-Al₂O₃) powder with a specific surface area of 10 m²/g and a pore volume of 0.076 cm³/g were calcined at 600° C. for 5 hours under static air.

Synthesis of Catalyst-10 (α-Al₂O₃ and 1 weight % K per catalyst) 10 g of alpha-alumina (α-Al₂O₃) powder with a specific surface area of 10 m²/g and a pore volume of 0.076 cm³/g were loaded with 1 weight % potassium (K) using wetness-impregnation. 2.58 mL of 1 Molar KHCO₃ aqueous solution was added to the solid α-Al₂O₃ at once, and then mixed until a homogenous paste was obtained. The homogenous paste was dried at 120° C. for 24 hours. The dried sample was calcined at 600° C. for 5 hours under static air. The resulting catalyst comprises α-Al₂O₃ and 1 weight % K per catalyst, and the resulting catalyst has a specific surface area of 8.52 m²/g and a pore volume of 0.061 cm³/g.

Synthesis of Catalyst-11 (α-Al₂O₃ and 3 weight % K per catalyst) 10 g of alpha-alumina (α-Al₂O₃) powder with a specific surface area of 10 m²/g and a pore volume of 0.076 cm³/g were loaded with 3 weight % potassium (K) using wetness-impregnation. 3.95 mL of 2 Molar KHCO₃ aqueous solution was added to the solid α-Al₂O₃ at once, and then mixed until a homogenous paste was obtained. The homogenous paste was dried at 120° C. for 24 hours. The dried sample was calcined at 600° C. for 5 hours under static air. The resulting catalyst comprises α-Al₂O₃ and 3 weight % K per catalyst, and the resulting catalyst has a specific surface area of 6.55 m²/g and a pore volume of 0.049 cm³/g.

Synthesis of Catalyst-12 (α-Al₂O₃ and 5 weight % K per catalyst) 10 g of alpha-alumina (α-Al₂O₃) powder with a specific surface area of 10 m²/g and a pore volume of 0.076 cm³/g were loaded with 5 weight % potassium (K) using wetness-impregnation. 4.49 mL of 3 Molar KHCO₃ aqueous solution was added to the solid α-Al₂O₃ at once, and then mixed until a homogenous paste was obtained. The homogenous paste was dried at 120° C. for 24 hours. The dried sample was calcined at 600° C. for 5 hours under static air. The resulting catalyst comprises α-Al₂O₃ and 3 weight % K per catalyst, and the resulting catalyst has a specific surface area of 4.21 m²/g and a pore volume of 0.045 cm³/g.

Synthesis of Catalyst-13 (α-Al₂O₃ and 3.3 weight % Cs per catalyst) 10 g of alpha-alumina (α-Al₂O₃) powder with a specific surface area of 10 m²/g and a pore volume of 0.076 cm³/g were loaded with 3.3 weight % cesium (caesium) (Cs) using wetness-impregnation. 2.58 mL of 0.5 Molar Cs₂CO₃ aqueous solution was added to the solid α-Al₂O₃ at once, and then mixed until a homogenous paste was obtained. The homogenous paste was dried at 120° C. for 24 hours. The dried sample was calcined at 600° C. for 5 hours under static air. The resulting catalyst comprises α-Al₂O₃ and 3.3 weight % Cs per catalyst, and the resulting catalyst has a specific surface area of 7.97 m²/g and a pore volume of 0.062 cm³/g.

Synthesis of Catalyst-14 (α-Al₂O₃ and 5 weight % Cs per catalyst) 10 g of alpha-alumina (α-Al₂O₃) powder with a specific surface area of 10 m²/g and a pore volume of 0.076 cm³/g were loaded with 5 weight % cesium (caesium) (Cs) using wetness-impregnation. 3.96 mL of 0.5 Molar Cs₂CO₃ aqueous solution was added to the solid α-Al₂O₃ at once, and then mixed until a homogenous paste was obtained. The homogenous paste was dried at 120° C. for 24 hours. The dried sample was calcined at 600° C. for 5 hours under static air. The resulting catalyst comprises α-Al₂O₃ and 5 weight % Cs per catalyst, and the resulting catalyst has a specific surface area of 7.25 m²/g and a pore volume of 0.060 cm³/g.

Synthesis of Catalyst-15 (α-Al₂O₃ and 9.5 weight % Cs per catalyst) 10 g of alpha-alumina (α-Al₂O₃) powder with a specific surface area of 10 m²/g and a pore volume of 0.076 cm³/g were loaded with 9.5 weight % cesium (caesium) (Cs) using wetness-impregnation. 7.90 mL of 0.5 Molar Cs₂CO₃ aqueous solution was added to the solid α-Al₂O₃ at once, and then mixed until a homogenous paste was obtained. The homogenous paste was dried at 120° C. for 24 hours. The dried sample was calcined at 600° C. for 5 hours under static air. The resulting catalyst comprises α-Al₂O₃ and 9.5 weight % Cs per catalyst, and the resulting catalyst has a specific surface area of 6.12 m²/g and a pore volume of 0.049 cm³/g.

Synthesis of Catalyst-16 (α-Al₂O₃ and 1.79 weight % Na per catalyst) 10 g of alpha-alumina (α-Al₂O₃) powder with a specific surface area of 10 m²/g and a pore volume of 0.076 cm³/g were loaded with 1.79 weight % sodium (Na) using wetness-impregnation. 3.96 mL of 2 Molar NaNO₃ aqueous solution was added to the solid α-Al₂O₃ at once, and then mixed until a homogenous paste was obtained. The homogenous paste was dried at 120° C. for 24 hours. The dried sample was calcined at 600° C. for 5 hours under static air. The resulting catalyst comprises α-Al₂O₃ and 1.79 weight % Na per catalyst, and the resulting catalyst has a specific surface area of 7.88 m²/g and a pore volume of 0.060 cm³/g.

Synthesis of Catalyst-17 (α-Al₂O₃ and 3 weight % Na per catalyst) 10 g of alpha-alumina (α-Al₂O₃) powder with a specific surface area of 10 m²/g and a pore volume of 0.076 cm³/g were loaded with 3 weight % sodium (Na) using wetness-impregnation. 4.48 mL of 3 Molar NaNO₃ aqueous solution was added to the solid α-Al₂O₃ at once, and then mixed until a homogenous paste was obtained. The homogenous paste was dried at 120° C. for 24 hours. The dried sample was calcined at 600° C. for 5 hours under static air. The resulting catalyst comprises α-Al₂O₃ and 3 weight % Na per catalyst, and the resulting catalyst has a specific surface area of 5.13 m²/g and a pore volume of 0.055 cm³/g.

Synthesis of Catalyst-18 (α-Al₂O₃ and 0.5 weight % Li per catalyst) 10 g of alpha-alumina (α-Al₂O₃) powder with a specific surface area of 10 m²/g and a pore volume of 0.076 cm³/g were loaded with 0.5 weight % lithium (Li) using wetness-impregnation. 3.62 mL of 2 Molar LiNO₃ aqueous solution was added to the solid α-Al₂O₃ at once, and then mixed until a homogenous paste was obtained. The homogenous paste was dried at 120° C. for 24 hours. The dried sample was calcined at 600° C. for 5 hours under static air. The resulting catalyst comprises α-Al₂O₃ and 0.5 weight % Li per catalyst, and the resulting catalyst has a specific surface area of 9.50 m²/g and a pore volume of 0.073 cm³/g.

Synthesis of Catalyst-19 (α-Al₂O₃ and 1.5 weight % Li per catalyst) 10 g of alpha-alumina (α-Al₂O₃) powder with a specific surface area of 10 m²/g and a pore volume of 0.076 cm³/g were loaded with 1.5 weight % lithium (Li) using wetness-impregnation. 5.49 mL of 4 Molar LiNO₃ aqueous solution was added to the solid α-Al₂O₃ at once, and then mixed until a homogenous paste was obtained. The homogenous paste was dried at 120° C. for 24 hours. The dried sample was calcined at 600° C. for 5 hours under static air. The resulting catalyst comprises α-Al₂O₃ and 1.5 weight % Li per catalyst, and the resulting catalyst has a specific surface area of 7.97 m²/g and a pore volume of 0.064 cm³/g.

Synthesis of Catalyst-20 (θ-Al₂O₃-pellet and 3 weight % K per catalyst) Gamma-alumina (γ-Al₂O₃-pellet) powder-pellets have a specific surface area of 265 m²/g and a pore volume of 0.896 cm³/g. 50 g of gamma-alumina (γ-Al₂O₃-pellet) powder-pellets were calcined at 950° C. for 18 hours under static air to produce theta-alumina (θ-Al₂O₃-pellet) powder-pellets. The product theta-alumina (θ-Al₂O₃-pellet) powder-pellets have a specific surface area of 127 m²/g and a pore volume of 0.721 cm³/g. The theta-alumina (θ-Al₂O₃-pellet) powder-pellets have an average size of around 10 millimeters (mm) to 20 mm. The product θ-Al₂O₃-pellets were loaded with 3 weight % potassium (K) using wetness-impregnation. The 10 g of the product θ-Al₂O₃-pellets were mixed with an aqueous potassium acetate and citric acid solution; the aqueous potassium acetate and citric acid solution comprises 0.7763 g potassium acetate (CH₃COOK) and 1.66 g citric acid monohydrate dissolved in 50 mL deionized water. After mixing, the water was removed by rotary evaporation. The solid was then heated at 120° C. for 24 hours. The dried sample was calcined at 600° C. for 5 hours under static air. The resulting catalyst comprises θ-Al₂O₃-pellet and 3 weight % K per catalyst, and the resulting catalyst has a specific surface area of 121.2 m²/g and a pore volume of 0.67 cm³/g. Citric acid monohydrate is a mixture of the compound citric acid and a water molecule in about a 1:1 ratio. Citric acid (HOOCCH₂-C(OH)(COOH)-CH₂COOH) is also known as 2-hydroxypropane-1,2,3-tricarboxylic acid.

### Examples—Results

TABLE 1

| | | | | | Feed | Feed |
|---|---|---|---|---|---|---|
| | Feed | CO₂ | Methane | CO | stream | stream |
| Catalyst | Composition | conversion | Selectivity | Selectivity | vol % | vol % |
| or Reagent | (CO₂:H₂) | (%) | (ppm) | (%) | of CO₂ | of H₂ |
| Reagent-1 | 1:1 | 29.57 | 20 | 99.998 | 50 | 50 |
| Reagent-1 | 1:2 | 40.09 | 78 | 99.992 | 33.33 | 66.66 |
| Reagent-1 | 1:3 | 47.09 | 172 | 99.983 | 25 | 75 |
| Reagent-1 | 1:4 | 52.36 | 283 | 99.972 | 20 | 80 |
| Reagent-1 | 1:5 | 56.47 | 400 | 99.960 | 16.67 | 83.33 |
| Catalyst-2 | 1:1 | 36.32 | 13 | 99.999 | 50 | 50 |
| Catalyst-2 | 1:2 | 49.09 | 50 | 99.995 | 33.33 | 66.66 |
| Catalyst-2 | 1:3 | 56.98 | 123 | 99.988 | 25 | 75 |
| Catalyst-2 | 1:4 | 62.53 | 212 | 99.979 | 20 | 80 |
| Catalyst-2 | 1:5 | 66.66 | 310 | 99.969 | 16.67 | 83.33 |
| Catalyst-3 | 1:1 | 45.12 | 8 | 99.999 | 50 | 50 |
| Catalyst-3 | 1:2 | 60.83 | 29 | 99.997 | 33.33 | 66.66 |
| Catalyst-3 | 1:3 | 69.39 | 76 | 99.992 | 25 | 75 |
| Catalyst-3 | 1:4 | 74.83 | 150 | 99.985 | 20 | 80 |
| Catalyst-3 | 1:5 | 78.59 | 216 | 99.978 | 16.67 | 83.33 |
| Catalyst-4 | 1:1 | 45.93 | 1 | 100.00 | 50 | 50 |
| Catalyst-4 | 1:2 | 61.46 | 23 | 99.998 | 33.33 | 66.66 |
| Catalyst-4 | 1:3 | 69.88 | 65 | 99.993 | 25 | 75 |
| Catalyst-4 | 1:4 | 75.43 | 141 | 99.986 | 20 | 80 |
| Catalyst-4 | 1:5 | 82.65 | 228 | 99.977 | 16.67 | 83.33 |

Table 1 reports RWGS reaction results for reagent 1 and catalysts 2-4 with a reaction temperature of 750° C. at atm for the reactions. Al₂O₃ may indirectly participate in the RWGS reactions by enhancing CO₂ absorption.

TABLE 2

| | | | | | Feed | Feed |
|---|---|---|---|---|---|---|
| | Feed | CO₂ | Methane | CO | stream | stream |
| Catalyst | Composition | conversion | Selectivity | Selectivity | vol % | vol % |
| or Reagent | (CO₂:H₂) | (%) | (ppm) | (%) | of CO₂ | of H₂ |
| Reagent-5 | 1:1 | 26.38 | 53 | 99.995 | 50 | 50 |
| Reagent-5 | 1:2 | 35.71 | 191 | 99.981 | 33.33 | 66.66 |
| Reagent-5 | 1:3 | 41.54 | 366 | 99.963 | 25 | 75 |
| Reagent-5 | 1:4 | 46.96 | 510 | 99.949 | 20 | 80 |
| Reagent-5 | 1:5 | 50.76 | 683 | 99.932 | 16.67 | 83.33 |
| Catalyst-6 | 1:1 | 37.26 | 3 | 100.000 | 50 | 50 |
| Catalyst-6 | 1:2 | 50.83 | 22 | 99.998 | 33.33 | 66.66 |
| Catalyst-6 | 1:3 | 59.13 | 61 | 99.994 | 25 | 75 |
| Catalyst-6 | 1:4 | 64.58 | 123 | 99.988 | 20 | 80 |
| Catalyst-6 | 1:5 | 68.15 | 211 | 99.979 | 16.67 | 83.33 |
| Catalyst-7 | 1:1 | 45.46 | 6 | 99.999 | 50 | 50 |
| Catalyst-7 | 1:2 | 61.20 | 26 | 99.997 | 33.33 | 66.66 |
| Catalyst-7 | 1:3 | 69.70 | 67 | 99.993 | 25 | 75 |
| Catalyst-7 | 1:4 | 75.00 | 128 | 99.987 | 20 | 80 |
| Catalyst-7 | 1:5 | 78.64 | 209 | 99.979 | 16.67 | 83.33 |
| Catalyst-8 | 1:1 | 45.43 | 8 | 99.999 | 50 | 50 |
| Catalyst-8 | 1:2 | 61.10 | 22 | 99.998 | 33.33 | 66.66 |
| Catalyst-8 | 1:3 | 69.53 | 62 | 99.994 | 25 | 75 |
| Catalyst-8 | 1:4 | 74.92 | 112 | 99.989 | 20 | 80 |
| Catalyst-8 | 1:5 | 78.67 | 197 | 99.980 | 16.67 | 83.33 |

Table 2 reports RWGS reaction results for reagent 5 and catalysts 6-8 with a reaction temperature of 750° C. at atm for the reactions.

TABLE 3

| | | | | | Feed | Feed |
|---|---|---|---|---|---|---|
| | Feed | CO₂ | Methane | CO | stream | stream |
| Catalyst | Composition | conversion | Selectivity | Selectivity | vol % | vol % |
| or Reagent | (CO₂:H₂) | (%) | (ppm) | (%) | of CO₂ | of H₂ |
| Reagent-9 | 1:1 | 7.93 | 89 | 99.991 | 50 | 50 |
| Reagent-9 | 1:2 | 11.43 | 133 | 99.987 | 33.33 | 66.66 |
| Reagent-9 | 1:3 | 14.03 | 186 | 99.981 | 25 | 75 |
| Reagent-9 | 1:4 | 16.16 | 200 | 99.980 | 20 | 80 |
| Reagent-9 | 1:5 | 17.92 | 257 | 99.974 | 16.67 | 83.33 |
| Catalyst-10 | 1:1 | 29.62 | 77 | 99.992 | 50 | 50 |
| Catalyst-10 | 1:2 | 42.92 | 129 | 99.987 | 33.33 | 66.66 |
| Catalyst-10 | 1:3 | 51.78 | 197 | 99.980 | 25 | 75 |
| Catalyst-10 | 1:4 | 58.30 | 300 | 99.970 | 20 | 80 |
| Catalyst-10 | 1:5 | 63.12 | 381 | 99.962 | 16.67 | 83.33 |
| Catalyst-11 | 1:1 | 33.85 | 22 | 99.998 | 50 | 50 |
| Catalyst-11 | 1:2 | 48.24 | 133 | 99.987 | 33.33 | 66.66 |
| Catalyst-11 | 1:3 | 56.86 | 185 | 99.982 | 25 | 75 |
| Catalyst-11 | 1:4 | 62.39 | 311 | 99.969 | 20 | 80 |
| Catalyst-11 | 1:5 | 66.42 | 338 | 99.966 | 16.67 | 83.33 |
| Catalyst-12 | 1:1 | 35.27 | 30 | 99.997 | 50 | 50 |
| Catalyst-12 | 1:2 | 48.63 | 69 | 99.993 | 33.33 | 66.66 |
| Catalyst-12 | 1:3 | 56.29 | 128 | 99.987 | 25 | 75 |
| Catalyst-12 | 1:4 | 61.15 | 176 | 99.982 | 20 | 80 |
| Catalyst-12 | 1:5 | 64.68 | 213 | 99.979 | 16.67 | 83.33 |

Table 3 reports RWGS reaction results reagent 9 and catalysts 10-12 with a reaction temperature of 650° C. at atm for the reactions.

TABLE 4

| | | | | | Feed | Feed |
|---|---|---|---|---|---|---|
| | Feed | CO₂ | Methane | CO | stream | stream |
| Catalyst | Composition | conversion | Selectivity | Selectivity | vol % | vol % |
| or Reagent | (CO₂:H₂) | (%) | (ppm) | (%) | of CO₂ | of H₂ |
| Reagent-9 | 1:1 | 20.11 | 47 | 99.995 | 50 | 50 |
| Reagent-9 | 1:2 | 28.50 | 105 | 99.990 | 33.33 | 66.66 |
| Reagent-9 | 1:3 | 34.27 | 186 | 99.981 | 25 | 75 |
| Reagent-9 | 1:4 | 38.72 | 336 | 99.966 | 20 | 80 |
| Reagent-9 | 1:5 | 42.41 | 461 | 99.954 | 16.67 | 83.33 |
| Catalyst-10 | 1:1 | 41.46 | 39 | 99.996 | 50 | 50 |
| Catalyst-10 | 1:2 | 57.07 | 62 | 99.994 | 33.33 | 66.66 |
| Catalyst-10 | 1:3 | 65.82 | 116 | 99.988 | 25 | 75 |
| Catalyst-10 | 1:4 | 71.53 | 191 | 99.981 | 20 | 80 |
| Catalyst-10 | 1:5 | 75.46 | 281 | 99.972 | 16.67 | 83.33 |
| Catalyst-11 | 1:1 | 44.72 | 27 | 99.997 | 50 | 50 |
| Catalyst-11 | 1:2 | 60.04 | 35 | 99.997 | 33.33 | 66.66 |
| Catalyst-11 | 1:3 | 67.27 | 67 | 99.993 | 25 | 75 |
| Catalyst-11 | 1:4 | 72.97 | 115 | 99.988 | 20 | 80 |
| Catalyst-11 | 1:5 | 77.76 | 202 | 99.980 | 16.67 | 83.33 |
| Catalyst-12 | 1:1 | 44.43 | 8 | 99.999 | 50 | 50 |
| Catalyst-12 | 1:2 | 60.10 | 22 | 99.998 | 33.33 | 66.66 |
| Catalyst-12 | 1:3 | 68.53 | 62 | 99.994 | 25 | 75 |
| Catalyst-12 | 1:4 | 73.92 | 112 | 99.989 | 20 | 80 |
| Catalyst-12 | 1:5 | 77.67 | 197 | 99.980 | 16.67 | 83.33 |

Table 4 reports RWGS reaction results reagent 9 and catalysts 10-12 with a reaction temperature of 750° C. at atm for the reactions.

TABLE 5

| | | | | | Feed | Feed |
|---|---|---|---|---|---|---|
| | Feed | CO₂ | Methane | CO | stream | stream |
| | Composition | conversion | Selectivity | Selectivity | vol % | vol % |
| Catalyst | (CO₂:H₂) | (%) | (ppm) | (%) | of CO₂ | of H₂ |
| Catalyst-13 | 1:1 | 45.07 | 51 | 99.997 | 50 | 50 |
| Catalyst-13 | 1:2 | 58.91 | 39 | 99.997 | 33.33 | 66.66 |
| Catalyst-13 | 1:3 | 66.18 | 67 | 99.994 | 25 | 75 |
| Catalyst-13 | 1:4 | 71.21 | 109 | 99.991 | 20 | 80 |
| Catalyst-13 | 1:5 | 74.98 | 149 | 99.985 | 16.67 | 83.33 |
| Catalyst-14 | 1:1 | 46.60 | 51 | 99.995 | 50 | 50 |
| Catalyst-14 | 1:2 | 59.92 | 39 | 99.996 | 33.33 | 66.66 |
| Catalyst-14 | 1:3 | 67.05 | 67 | 99.993 | 25 | 75 |
| Catalyst-14 | 1:4 | 71.47 | 109 | 99.989 | 20 | 80 |
| Catalyst-14 | 1:5 | 74.68 | 149 | 99.985 | 16.67 | 83.33 |
| Catalyst-15 | 1:1 | 46.15 | 57 | 99.994 | 50 | 50 |
| Catalyst-15 | 1:2 | 61.66 | 55 | 99.995 | 33.33 | 66.66 |
| Catalyst-15 | 1:3 | 67.00 | 78 | 99.992 | 25 | 75 |
| Catalyst-15 | 1:4 | 71.04 | 112 | 99.989 | 20 | 80 |
| Catalyst-15 | 1:5 | 74.57 | 168 | 99.983 | 16.67 | 83.33 |

Table 5 reports RWGS reaction results catalysts 13-15 with a reaction temperature of 750° C. at atm for the reactions.

TABLE 6

| | | | | | Feed | Feed |
|---|---|---|---|---|---|---|
| | Feed | CO₂ | Methane | CO | stream | stream |
| | Composition | conversion | Selectivity | Selectivity | vol % | vol % |
| Catalyst | (CO₂:H₂) | (%) | (ppm) | (%) | of CO₂ | of H₂ |
| Catalyst-16 | 1:1 | 43.33 | 20 | 99.998 | 50 | 50 |
| Catalyst-16 | 1:2 | 58.35 | 28 | 99.997 | 33.33 | 66.66 |
| Catalyst-16 | 1:3 | 66.76 | 54 | 99.995 | 25 | 75 |
| Catalyst-16 | 1:4 | 72.18 | 97 | 99.990 | 20 | 80 |
| Catalyst-16 | 1:5 | 76.10 | 146 | 99.985 | 16.67 | 83.33 |
| Catalyst-17 | 1:1 | 42.33 | 21 | 99.998 | 50 | 50 |
| Catalyst-17 | 1:2 | 57.52 | 28 | 99.997 | 33.33 | 66.66 |
| Catalyst-17 | 1:3 | 66.14 | 53 | 99.995 | 25 | 75 |
| Catalyst-17 | 1:4 | 72.02 | 96 | 99.990 | 20 | 80 |
| Catalyst-17 | 1:5 | 76.07 | 139 | 99.986 | 16.67 | 83.33 |
| Catalyst-18 | 1:1 | 30.42 | 12 | 99.999 | 50 | 50 |
| Catalyst-18 | 1:2 | 42.52 | 30 | 99.997 | 33.33 | 66.66 |
| Catalyst-18 | 1:3 | 50.44 | 78 | 99.992 | 25 | 75 |
| Catalyst-18 | 1:4 | 55.87 | 136 | 99.986 | 20 | 80 |
| Catalyst-18 | 1:5 | 59.84 | 205 | 99.980 | 16.67 | 83.33 |
| Catalyst-19 | 1:1 | 30.25 | 16 | 99.998 | 50 | 50 |
| Catalyst-19 | 1:2 | 43.65 | 31 | 99.997 | 33.33 | 66.66 |
| Catalyst-19 | 1:3 | 53.39 | 59 | 99.994 | 25 | 75 |
| Catalyst-19 | 1:4 | 61.10 | 108 | 99.989 | 20 | 80 |
| Catalyst-19 | 1:5 | 67.24 | 152 | 99.985 | 16.67 | 83.33 |

Table 6 reports RWGS reaction results catalysts 16-19 with a reaction temperature of 750° C. at atm for the reactions.

TABLE 7

| | | | | | Feed | Feed |
|---|---|---|---|---|---|---|
| | Feed | CO₂ | Methane | CO | stream | stream |
| | Composition | conversion | Selectivity | Selectivity | vol % | vol % |
| Catalyst | (CO₂:H₂) | (%) | (ppm) | (%) | of CO₂ | of H₂ |
| Catalyst-20 | 1:1 | 45.35 | 8 | 99.999 | 50 | 50 |
| Catalyst-20 | 1:2 | 61.01 | 24 | 99.998 | 33.33 | 66.66 |
| Catalyst-20 | 1:3 | 69.57 | 59 | 99.994 | 25 | 75 |
| Catalyst-20 | 1:4 | 74.90 | 115 | 99.988 | 20 | 80 |
| Catalyst-20 | 1:5 | 78.63 | 187 | 99.981 | 16.67 | 83.33 |

Table 7 reports RWGS reaction results catalyst 20 with a reaction temperature of 750° C. at atm for the reactions.

TABLE 8

| | | | | | Feed | Feed |
|---|---|---|---|---|---|---|
| | Feed | CO₂ | Methane | CO | stream | stream |
| | Composition | conversion | Selectivity | Selectivity | vol % | vol % |
| Catalyst | (CO₂:H₂) | (%) | (%) | (%) | of CO₂ | of H₂ |
| Catalyst-20 | 1:1 | 45.91 | 0.018 | 99.982 | 50 | 50 |
| Catalyst-20 | 1:2 | 61.63 | 0.084 | 99.916 | 33.33 | 66.66 |
| Catalyst-20 | 1:3 | 70.06 | 0.201 | 99.799 | 25 | 75 |
| Catalyst-20 | 1:4 | 75.38 | 0.306 | 99.694 | 20 | 80 |
| Catalyst-20 | 1:5 | 79.11 | 0.512 | 99.488 | 16.67 | 83.33 |

Table 8 reports RWGS reaction results catalyst 20 with a reaction temperature of 750° C. at 5 bar gauge (barg) for the reactions.

General Trends for the Reactions. General trends seen over all examples included: the CO₂ conversion increased as the ratio of CO₂ to H₂ in the feed stream increased; the selectivity for CO formation increased as the ratio of CO₂ to H₂ in the feed composition decreased; and the CO₂ conversion increased (up to equilibrium/maximum conversion values) with increasing alkali metal amount in the catalysts. Another general trend seen over all examples was the selectivity for CH₄ formation decreased with an increasing amount of alkali metal in the catalysts. Though not to be bound by theory, this suggests that the alkali metal is reducing the acidity of the alumina (Al₂O₃), since the acidity is the main driver for the secondary hydrogenation reactions of CO to CH₄.

The present disclosure is further directed to the following non-limiting clauses: Clause 1. A catalyst comprising: alumina in a phase selected from the group consisting of alpha-alumina (α-Al₂O₃) phase, theta-alumina (θ-Al₂O₃) phase, gamma-alumina (γ-Al₂O₃) phase, and any combination thereof; and an alkali metal in an amount of about 1 weight % to about 9.5 weight % per the catalyst; wherein the catalysts are in a form of a plurality of particles having an average particle size of about 200 micrometers to about 500 micrometers.

Clause 2. The catalyst of clause 1, wherein the alkali metal is selected from the group consisting of lithium (Li), sodium (Na), potassium (K), cesium (caesium) (Cs), and any combination thereof.

Clause 3. The catalyst of clause 1 or clause 2, wherein the alkali metal is selected from the group consisting of lithium (Li), potassium (K), cesium (caesium) (Cs), and any combination thereof.

Clause 4. The catalyst of any one of clauses 1-3, wherein the amount of the alkali metal is about 1 weight % to about 6 weight % per the catalyst.

Clause 5. The catalyst of any one of clauses 1-4, wherein the catalyst comprises γ-Al₂O₃ and about 5 weight % of the potassium (K) per the catalyst.

Clause 6. The catalyst of any one of clauses 1-5, wherein the catalyst comprises θ-Al₂O₃ and about 1 weight % of the potassium (K) per the catalyst.

Clause 7. A method comprising: combining alumina (Al₂O₃) and a solution comprising an alkali metal compound to produce a homogeneous paste; drying the homogeneous paste at about 120° C. for at least about 24 hours; and calcining the homogenous paste for at least about 1 hour at a calcining temperature of at least about 550° C. to produce a catalyst comprising the alkali metal and the alumina.

Clause 8. The method of clause 7, wherein the alumina is in a phase selected from the group consisting of alpha-alumina (α-Al₂O₃) phase, theta-alumina (θ-Al₂O₃) phase, gamma-alumina (γ-Al₂O₃) phase, and any combination thereof.

Clause 9. The method of clause 7 or clause 8, wherein the calcining occurs at a calcining temperature of about 550° C. to about 750° C.

Clause 10. The method of any one of clauses 7-9, wherein the catalyst comprises γ-Al₂O₃ and about 5 weight % of potassium (K) per the catalyst; wherein the solution comprises a KHCO₃ aqueous mixture; and wherein the calcining temperature is about 600° C. for about 5 hours under static air.

Clause 11. The method of any one of clauses 7-9, wherein the catalyst comprises θ-Al₂O₃ and about 1 weight % of potassium (K) per the catalyst; wherein the solution comprises a KHCO₃ aqueous mixture; and wherein the calcining temperature is about 600° C. for about 5 hours under static air.

Clause 12. The method of any one of clauses 7-11, further comprising: processing the catalyst to produce a plurality of particles having an average particle size of about 200 micrometers to about 500 micrometers.

Clause 13. The method of any one of clauses 7-9 or 12, wherein the alkali metal compound comprises an alkali metal selected from the group consisting of lithium (Li), sodium (Na), potassium (K), cesium (caesium) (Cs), and any combination thereof; and wherein the alkali metal compound is selected from the group consisting of alkali metal nitrates, alkali metal chlorides, alkali metal carbonates, alkali metal bicarbonates (alkali metal hydrogencarbonates), alkali metal benzoates, alkali metal acetylacetonates, alkali metal acetates, and any combination thereof.

Clause 14. A method comprising: introducing the catalyst of any one of clauses 1-6 into a chemical reactor; activating the catalysts by heating the catalysts to an activation temperature of at least about 650° C. at a rate of about 5° C./min to about 15° C./min under argon; flowing a feed composition at a Gas Hourly Space Velocity of about 3300 mL (grams of catalyst)⁻¹ hour⁻¹ to about 13,200 mL (grams of catalyst)⁻¹ hour⁻¹ into the chemical reactor, wherein the feed composition comprises CO₂ and H₂; maintaining the chemical reactor at a reaction temperature of about 550° C. to about 900° C. and at a pressure of about atmospheric pressure to about 5 bar gauge (barg); and recovering a first mixture stream leaving the chemical reactor, wherein the first mixture stream comprises: water (H₂O) vapor, unreacted carbon dioxide (CO₂) gas, unreacted hydrogen (H₂) gas, and carbon monoxide (CO) gas.

Clause 15. The method of clause 14, wherein the feed composition has a CO₂:H₂ ratio of about 1:1 to about 1:5.

Clause 16. The method of clause 14 or clause 15, further comprising: removing the water (H₂O) vapor from the first mixture stream to generate a second mixture stream, wherein the second mixture stream comprises: the carbon monoxide (CO) gas from the first mixture stream, the unreacted carbon dioxide (CO₂) gas from the first mixture stream, and the unreacted hydrogen (H₂) gas from the first mixture stream.

Clause 17. The method of clause 16, further comprising: recovering the unreacted carbon dioxide (CO₂) from the second mixture stream to form a syngas mixture stream; and then optionally, utilizing the syngas mixture stream; wherein the syngas mixture stream comprises the carbon monoxide (CO) gas from the second mixture stream and the unreacted hydrogen (H₂) gas from the second mixture stream.

Clause 18. The method of clause 17, further comprising: recovering the unreacted hydrogen (H₂) gas from the syngas mixture stream to produce a first stream of carbon monoxide; and then optionally, utilizing the first stream of carbon monoxide; wherein the first stream of carbon monoxide comprises the carbon monoxide (CO) gas from the syngas mixture stream.

Clause 19. The method of clause 16, further comprising: recovering the unreacted hydrogen (H₂) gas from the second mixture stream to generate a third mixture stream, wherein the third mixture stream comprises the carbon monoxide (CO) gas from the second mixture stream and the unreacted carbon dioxide (CO₂) gas from the second mixture stream.

Clause 20. The method of clause 19, further comprising: recovering the unreacted carbon dioxide (CO₂) from the third mixture stream to form a second stream of carbon monoxide; and then optionally, utilizing the second stream of carbon monoxide; wherein the second stream of carbon monoxide comprises the carbon monoxide (CO) gas from the third mixture stream.

Clause 21. The method of any one of clauses 14-20, wherein the reaction temperature is about 700° C. to about 900° C.

Clause 22. The method of any one of clauses 14-21, wherein the chemical reactor is a fixed-bed reactor.

Clause 23. The method of any one of clauses 14-22, wherein the catalyst comprises γ-Al₂O₃ and about 5 weight % of potassium (K) per the catalyst in the fixed-bed reactor; wherein the feed composition has a CO₂:H₂ ratio of about 1:1 to about 1:5; wherein the reaction temperature is about 750° C. and the pressure is about atmospheric pressure; and wherein the Gas Hourly Space Velocity is about 6600 mL (grams of catalyst)⁻¹ hour⁻¹.

Clause 24. The method of any one of clause 14-22, wherein the catalyst comprises θ-Al₂O₃ and about 1 weight % of potassium (K) per the catalyst in the fixed-bed reactor; wherein the feed composition has a CO₂:H₂ ratio of about 1:1, wherein the reaction temperature is about 750° C. and the pressure is about atmospheric pressure; and wherein the Gas Hourly Space Velocity is about 6600 mL (grams of catalyst)⁻¹ hour⁻¹.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains,” “containing,” “includes,” “including,” “comprises,” and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

While the present disclosure has been described with respect to a limited number of embodiments, those skilled in the art, having benefit of this disclosure, will appreciate that other embodiments may be devised which do not depart from the scope of the disclosure as described herein. Accordingly, the scope of the disclosure should be limited only by the attached claims.

All documents described herein are incorporated by reference herein for purposes of all jurisdictions where such practice is allowed, including any priority documents and/or testing procedures to the extent they are not inconsistent with this text. As is apparent from the foregoing general description and the specific embodiments, while forms of the disclosure have been illustrated and described, various modifications can be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by one or more embodiments described herein. At the very least, and not as an attempt to limit the application of the doctrine of equivalents to the scope of the claim, each numerical parameter should at least be construed in light of the number of reported significant digits and by applying ordinary rounding techniques.

The invention claimed is:

1. A catalyst comprising:
alumina in a phase selected from the group consisting of alpha-alumina (α-Al₂O₃) phase, theta-alumina (θ-Al₂O₃) phase, gamma-alumina (γ-Al₂O₃) phase, and any combination thereof; and
an alkali metal in an amount of about 1 weight % to about 9.5 weight % per the catalyst;
wherein the catalyst is in a form of a plurality of particles having an average particle size of about 200 micrometers to about 500 micrometers.

2. The catalyst of claim 1, wherein the alkali metal is selected from the group consisting of lithium (Li), sodium (Na), potassium (K), cesium (caesium) (Cs), and any combination thereof.

3. The catalyst of claim 1, wherein the alkali metal is selected from the group consisting of lithium (Li), potassium (K), cesium (caesium) (Cs), and any combination thereof.

4. The catalyst of claim 1, wherein the amount of the alkali metal is about 1 weight % to about 6 weight % per the catalyst.

5. The catalyst of claim 2, wherein the catalyst comprises γ-Al₂O₃ and about 5 weight % of the potassium (K) per the catalyst.

6. The catalyst of claim 2, wherein the catalyst comprises θ-Al₂O₃ and about 1 weight % of the potassium (K) per the catalyst.

7. A method comprising:
combining alumina (Al₂O₃) and a solution comprising an alkali metal compound to produce a homogeneous paste;
drying the homogeneous paste at about 120° C. for at least about 24 hours; and
calcining the homogenous paste for at least about 1 hour at a calcining temperature of at least about 550° C. to produce a catalyst comprising the alkali metal and the alumina.

8. The method of claim 7, wherein the alumina is in a phase selected from the group consisting of alpha-alumina (α-Al₂O₃) phase, theta-alumina (θ-Al₂O₃) phase, gamma-alumina (γ-Al₂O₃) phase, and any combination thereof.

9. The method of claim 7, wherein the calcining temperature is about 550° C. to about 750° C.

10. The method of claim 8, wherein the catalyst comprises γ-Al₂O₃ and about 5 weight % of potassium (K) per the catalyst; wherein the solution comprises a KHCO₃ aqueous mixture; and wherein the calcining temperature is about 600° C. for about 5 hours under static air.

11. The method of claim 8, wherein the catalyst comprises θ-Al₂O₃ and about 1 weight % of potassium (K) per the catalyst; wherein the solution comprises a KHCO₃ aqueous mixture; and wherein the calcining temperature is about 600° C. for about 5 hours under static air.

12. The method of claim 7, further comprising:
processing the catalyst to produce a plurality of particles having an average particle size of about 200 micrometers to about 500 micrometers.

13. The method of claim 7, wherein the alkali metal compound comprises an alkali metal selected from the group consisting of lithium (Li), sodium (Na), potassium (K), cesium (caesium) (Cs), and any combination thereof; and wherein the alkali metal compound is selected from the group consisting of alkali metal nitrates, alkali metal chlorides, alkali metal carbonates, alkali metal bicarbonates (alkali metal hydrogencarbonates), alkali metal benzoates, alkali metal acetylacetonates, alkali metal acetates, and any combination thereof.

14. A method comprising:
introducing the catalyst of claim 1 into a chemical reactor;
activating the catalyst by heating the catalyst to an activation temperature of at least about 650° C. at a rate of about 5° C./min to about 15° C./min under argon;
flowing a feed composition at a Gas Hourly Space Velocity of about 3300 mL (grams of catalyst)⁻¹ hour 1 to about 13,200 mL (grams of catalyst)⁻¹ hour⁻¹ into the chemical reactor, wherein the feed composition comprises CO₂ and H₂;
maintaining the chemical reactor at a reaction temperature of about 550° C. to about 900° C. and at a pressure of about atmospheric pressure to about 5 bar gauge (barg); and
recovering a first mixture stream leaving the chemical reactor, wherein the first mixture stream comprises:
water (H₂O) vapor, unreacted carbon dioxide (CO₂) gas, unreacted hydrogen (H₂) gas, and carbon monoxide (CO) gas.

15. The method of claim 14, wherein the feed composition has a CO₂:H₂ ratio of about 1:1 to about 1:5.

16. The method of claim 14, further comprising:
removing the water (H₂O) vapor from the first mixture stream to generate a second mixture stream, wherein the second mixture stream comprises: the carbon monoxide (CO) gas from the first mixture stream, the unreacted carbon dioxide (CO₂) gas from the first mixture stream, and the unreacted hydrogen (H₂) gas from the first mixture stream.

17. The method of claim 16, further comprising:
recovering the unreacted carbon dioxide (CO₂) from the second mixture stream to form a syngas mixture stream; and then optionally,
utilizing the syngas mixture stream;
wherein the syngas mixture stream comprises the carbon monoxide (CO) gas from the second mixture stream and the unreacted hydrogen (H₂) gas from the second mixture stream.

18. The method of claim 17, further comprising:
recovering the unreacted hydrogen (H₂) gas from the syngas mixture stream to produce a first stream of carbon monoxide; and then optionally,
utilizing the first stream of carbon monoxide;
wherein the first stream of carbon monoxide comprises the carbon monoxide (CO) gas from the syngas mixture stream.

19. The method of claim 16, further comprising:
recovering the unreacted hydrogen (H₂) gas from the second mixture stream to generate a third mixture stream,
wherein the third mixture stream comprises the carbon monoxide (CO) gas from the second mixture stream and the unreacted carbon dioxide (CO₂) gas from the second mixture stream.

20. The method of claim 19, further comprising:
recovering the unreacted carbon dioxide (CO₂) from the third mixture stream to form a second stream of carbon monoxide; and then optionally,
utilizing the second stream of carbon monoxide;
wherein the second stream of carbon monoxide comprises the carbon monoxide (CO) gas from the third mixture stream.

21. The method of claim 14, wherein the reaction temperature is about 700° C. to about 900° C.

22. The method of claim 14, wherein the chemical reactor is a fixed-bed reactor.

23. The method of claim 22, wherein the catalyst comprises γ-Al₂O₃ and about 5 weight % of potassium (K) per the catalyst in the fixed-bed reactor; wherein the feed composition has a CO₂:H₂ ratio of about 1:1 to about 1:5; wherein the reaction temperature is about 750° C. and the pressure is about atmospheric pressure; and wherein the Gas Hourly Space Velocity is about 6600 mL (grams of catalyst)⁻¹ hour⁻¹.

24. The method of claim 22, wherein the catalyst comprises θ-Al₂O₃ and about 1 weight % of potassium (K) per the catalyst in the fixed-bed reactor; wherein the feed composition has a CO₂:H₂ ratio of about 1:1, wherein the reaction temperature is about 750° C. and the pressure is about atmospheric pressure; and wherein the Gas Hourly Space Velocity is about 6600 mL (grams of catalyst)⁻¹ hour⁻¹.
